(19) United States
(12) Patent Application Publication
(10) Pub. No.: US 2017/0059234 A1
(43) Pub. Date: Mar. 2, 2017

(54) APPLIANCE IMPROVEMENTS

(71) Applicant: Danby Products Limited, Guelph (CA)

(72) Inventors: Jim Estill, Guelph (CA); Gregory Allen Thomas Hall, Guelph (CA); Bryan Stuart Cunningham, Kitchener (CA)

(21) Appl. No.: 15/239,395

(22) Filed: Aug. 17, 2016

Related U.S. Application Data
(60) Provisional application No. 62/211,765, filed on Aug. 29, 2015.
(60) Provisional application No. 62/262,954, filed on Dec. 4, 2015.

(51) Int. Cl. F25D 23/12; H05B 6/80; A47B 47/00; F25D 11/00

(52) U.S. Cl. CPC F25D 23/12; F25D 11/00; H05B 6/80; A47B 47/0075; F25D 2201/10; F25D 2400/40; A47B 2220/0091

(57) ABSTRACT

The exemplary apparatus includes an appliance that combines the functions of a compact refrigerator, microwave oven and safe for use in facilities such as hotels and dormitories. Power is supplied through power control circuitry which avoids undesirable power conditions. The safe portion includes safe circuitry which includes an alarm enunciator which provides an audible alarm in the event of detection of a safe tamper condition. A removable encasement within a refrigerator body provides vibration isolation to minimize vibration of the refrigerator portion and connected items. An insulating sleeve extends in surrounding relation of refrigerator walls to reduce heat infiltration therein.

### TECHNICAL FIELD

Exemplary embodiments relate to improvements to appliances. Specifically, exemplary embodiments relate to improvements to appliances that include compact refrigerator, microwave oven and safe functionality.

### BACKGROUND

Compact refrigerators are used for many different purposes. They are often found in dormitories, hotels, offices and other establishments. Compact refrigerators are also often used in housing units for storage of beverages in bar areas or entertainment areas. Compact refrigerators provide useful storage for refrigerated items without the requirement for the considerable floor space and power draw that is required for a full size refrigerator.

Compact refrigerators and appliances that include compact refrigerator functionality may benefit from improvements.

### BRIEF DESCRIPTION OF DRAWINGS

FIG. 1 is a front view of a compact refrigerator included as part of an appliance unit that includes a microwave oven and a safe.

FIG. 2 is an isometric rear view of the appliance shown in FIG. 1.

FIG. 3 is a schematic view of certain circuitry associated with the safe of an exemplary embodiment.

FIG. 4 is a schematic view of electrical components associated with the appliance.

FIG. 5 is an alternative arrangement for an appliance that includes a compact refrigerator, safe and microwave oven.

FIG. 6 is a partial front view showing a mounting arrangement for a safe in connection with a compact refrigerator.

FIG. 7 is a schematic transparent view of a compact refrigerator with a removable vibration isolating encasement.

FIG. 8 is an isometric schematic view of the refrigerator shown in FIG. 6.

FIG. 9 is an enlarged view of the refrigerator configuration shown in FIG. 7.

FIGS. 10-12 are isometric views showing a compact refrigerator with an insulating sleeve installed thereon.

FIG. 13 is an exploded view of a portion of the insulating sleeve.

FIG. 14 is a side view of a compact refrigerator showing an insulating sleeve including a decorative exterior.

FIG. 15 is a side view of an exemplary backing plate and insulation.

FIG. 16 is a side view showing how the backing plate and insulation may be conformed to an outside corner of a top wall and side wall of a refrigerator.

FIG. 17 is a plan view of a side portion of an exemplary insulating sleeve.

FIG. 18 is an isometric view of a connector clip used with an exemplary arrangement.

FIG. 19 is an exploded schematic view of a snap connect fastener used to hold an exemplary insulating sleeve in engagement with an exterior refrigerator wall.

FIG. 20 is a view similar to FIG. 19 showing the exemplary insulating sleeve folded at a bottom end 180 degrees at a bottom end and an exemplary fastener for holding the insulating sleeve in engagement with the refrigerator.

FIG. 21 is a top plan view of an exemplary bottom wall piece used in connection with an alternative safe configuration.

FIG. 22 is an isometric view representing how wall pieces of the alternative safe construction are held in engagement through resilient tabs and recesses.

FIG. 23 is a view similar to FIG. 22 with the tabs and recesses engaged.

FIG. 24 is a top isometric view of an exemplary tab.

FIG. 25 is a side view of an exemplary tab.

FIG. 26 is a front view of an exemplary tab.

FIG. 27 is an isometric view of the tab engaged in a recess.

FIG. 28 is a bottom plan view of an exemplary top wall piece.

FIG. 29 is a top isometric view of a side wall piece including a strike and strike opening.

FIG. 30 is a top right isometric view of the side wall piece of FIG. 29.

FIG. 31 is a top isometric view of a side wall piece that extends on a hinge side of the exemplary safe.

FIG. 32 is a top view of a back wall piece of the exemplary safe.

FIG. 33 is a top plan view of the bottom wall piece, two side wall pieces and back wall piece of an exemplary safe in assembled condition.

FIG. 34 is a front top isometric view of an exemplary safe door.

FIG. 35 is a back bottom isometric view of the safe door and a strike recess therein.

FIG. 36 is a back left isometric view of the safe door and a hinge pin recess therein and top and bottom hinge pins in the operative position.

FIG. 37 is a top view similar to FIG. 33 but with the safe door shown installed and in cross section.

### DETAILED DESCRIPTION

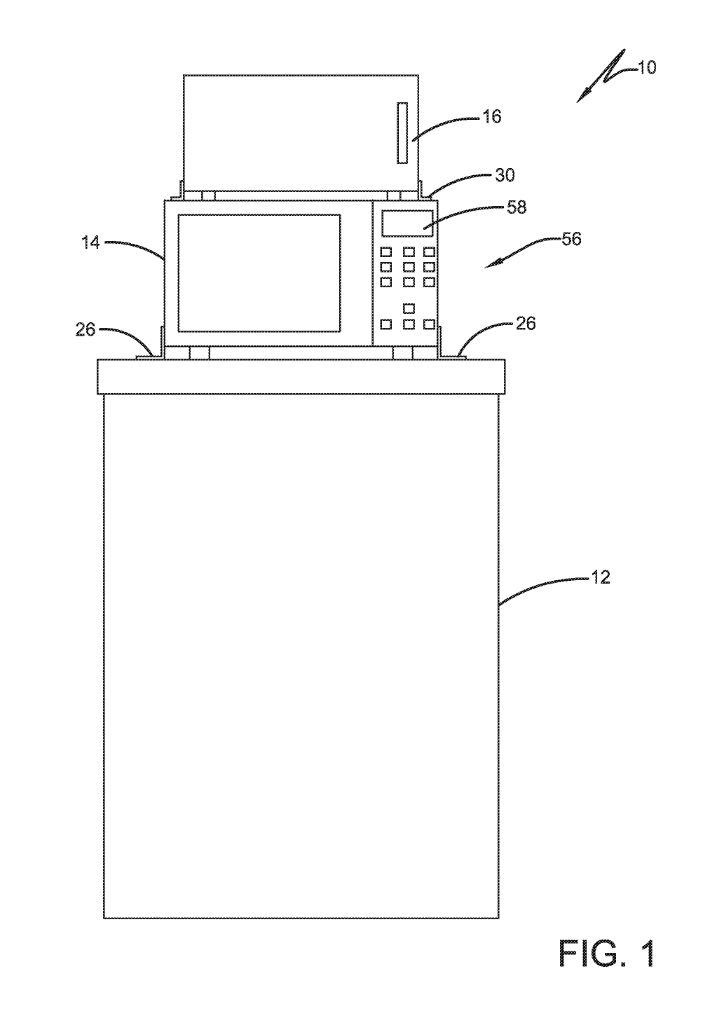

Referring now to the drawings and particularly to FIG. 1, there is shown therein an appliance generally indicated 10. Appliance 10 is an integrated operational appliance unit that performs the functions of a compact refrigerator, a microwave oven and a safe. Such an integrated appliance unit may be useful for example in hotels, dormitories or other facilities where the functions of refrigerated storage, cooking small items and securely storing valuables are required.

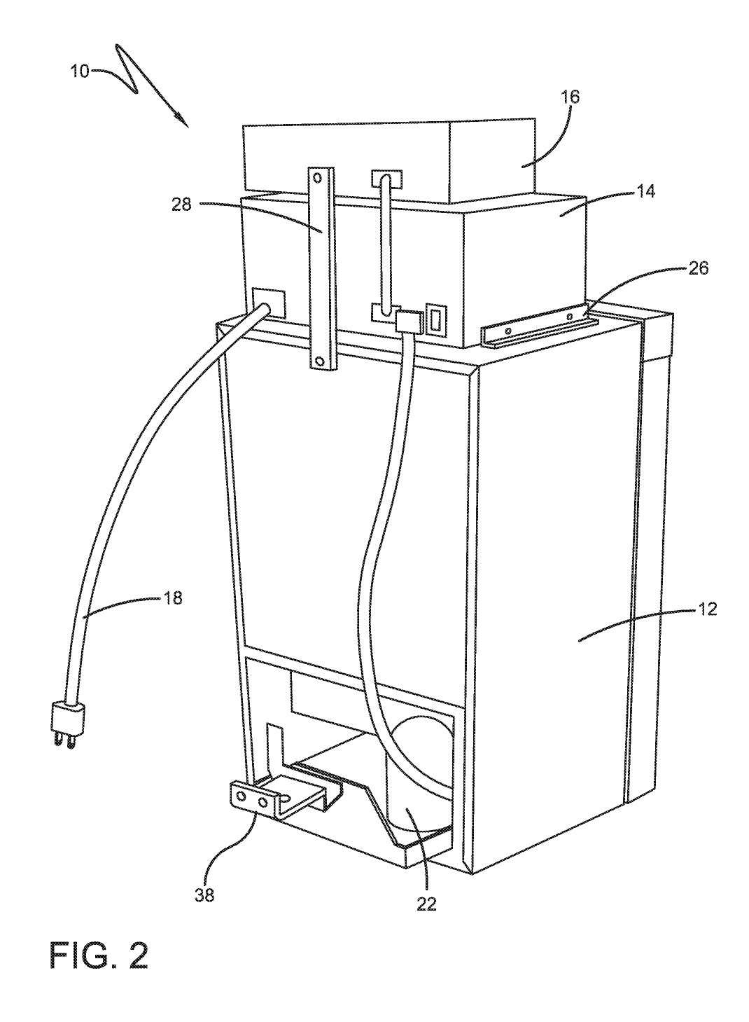

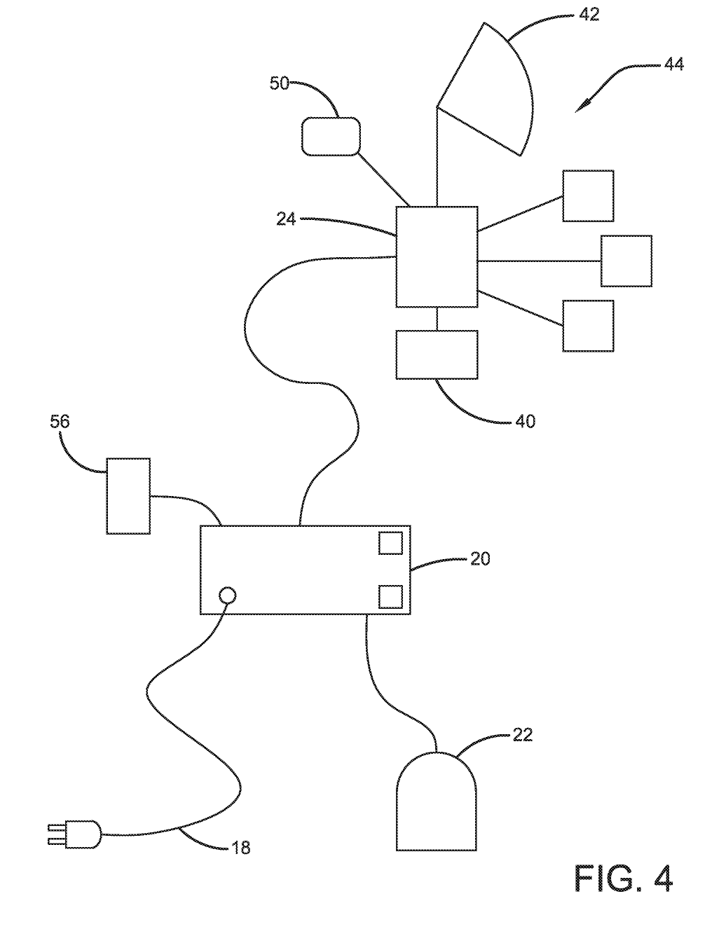

Appliance 10 includes a compact refrigerator portion 12. The refrigerator 12 is operative to support a microwave oven portion 14. The microwave oven 14 is supported in stacked relation on an upper surface of the refrigerator body. In this exemplary arrangement, a safe portion 16 is supported by an upper surface of the microwave oven. The exemplary appliance 10 is operative to utilize a single releasable connection to a source of household current as represented by power cord 18 in FIG. 2. The power cord of the exemplary arrangement is in operative connection with power control circuitry 20 as schematically represented in FIG. 4. The power control circuitry of the exemplary arrangement is operative to deliver power to the microwave and the refrigerator compressor 22 and other electrical components associated with the refrigerator 12. The exemplary power control circuitry 20 is also operative to deliver power to at least one safe circuit 24 that is included in the safe 16.

In the exemplary arrangement, the power control circuitry is operative to monitor the power draw or other conditions of the devices which draw the power during operation of the combined appliance. The exemplary power control circuitry is operative to avoid the combined power draw of the devices which make up the appliance from exceeding a set limit. For example in situations where the user wishes to operate the microwave while the refrigerator compressor is running and such condition would cause an excessive load, the power control circuitry is operative to withhold power to the compressor while the microwave operates. Such exemplary approaches enable the energy efficient operation of the appliance and serves to avoid an excessive power draw that may exceed the limits of a circuit breaker or associated wiring. Alternatively embodiments may be operative to withhold power to one or more other components of the unit when another component of the unit is operated. The exemplary embodiments may include features like those described in U.S. patent application Ser. No. 15/180,978 filed Jun. 13, 2016, the disclosure of which is incorporated herein by reference in its entirety.

Alternatively or in addition, exemplary embodiments of the power control circuitry may be operative to detect the connected status of one or more components of the microwave, refrigerator and/or safe to the power control circuitry. Such exemplary power control circuitry may be operative responsive to sensing that there is a loss of electrical connection to make a determination as to whether the condition is a result of vandalism or attempted theft of components of the appliance. In response to detecting an electrical disconnection, the exemplary power control circuitry may be operative to provide one or more wired or wireless signals so as to provide an indication to a monitoring station or individuals in the area of the appliance of the abnormal condition. In addition, the appliance may include an audible enunciator that is operative to provide audible alarm signals. Further in other exemplary arrangements, the exemplary power control circuitry may be operative to avoid the damaging effects of power fluctuations, power surges, power bursts caused by lightning strikes, and to provide other functions. Of course these functions are exemplary and in other arrangements, the power control circuitry may perform different or additional functions.

In the exemplary arrangement, the appliance includes brackets to reduce the risk of theft of the appliance and its components. In the exemplary arrangement shown in FIG. 2, brackets 26 extend on each side of the body of the microwave 14. Exemplary brackets 26 are connected via secure fasteners to the body of the refrigerator and the body of the microwave so as to resist the separation thereof. In the exemplary embodiment the fasteners used for connecting the brackets include screw heads that are configured to prevent the loosening or disconnection thereof using normal tools. Of course it should be understood that this bracket arrangement is exemplary and in other arrangements, other approaches may be used.

The exemplary arrangement further includes at least one bracket 28. The exemplary bracket 28 extends on the rear of the appliance. The bracket 28 directly operatively connects the refrigerator body and the safe body. Bracket 28 spans the intermediate component body of the microwave oven 14. Further in some exemplary arrangements, bracket 28 may include connections to the body of the microwave oven as well. Further it should be understood that while in the exemplary arrangement shown in FIGS. 1 and 2, the components of the appliance unit are stacked so that the microwave oven 14 is positioned intermediate of the refrigerator 12 and the safe 16, in other arrangements such as that hereinafter described, the safe may be positioned intermediate of the refrigerator and the microwave oven. In such arrangements, brackets such as bracket 28 may be usable to span the intermediate device so as to assure the connection of the refrigerator to the uppermost component of the appliance unit. In other embodiments other components such as the safe may be the bottom component. Other components such as the refrigerator, the microwave oven (and other components) may be positioned as the top component and at least one intermediate component.

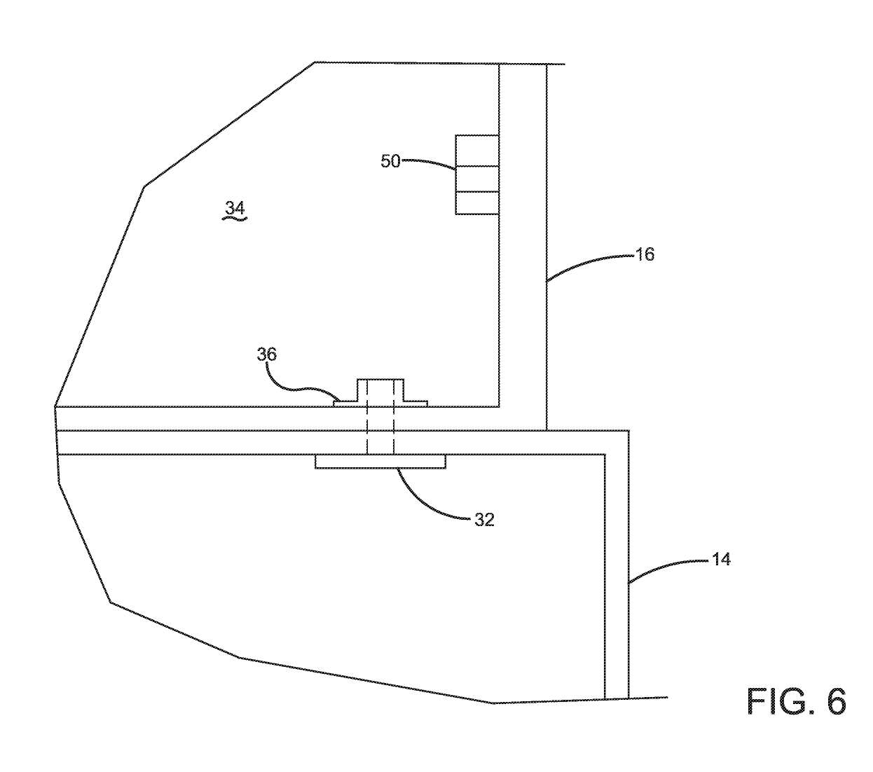

Further in exemplary arrangements, additional brackets may be used to secure the components together. For example as shown in FIG. 1, external brackets 30 are utilized to hold the body of the microwave and the body of the safe in engagement. In exemplary arrangements the brackets 30 may be similar to brackets 26 and be held to each of the microwave and the safe through fasteners that are configured to prevent disengagement. Alternatively or in addition, in some exemplary arrangements internal fasteners may be used. For example FIG. 6 shows an exemplary mounting arrangement for attaching the safe 16 in engagement with an underlying portion of the appliance such as the body of microwave oven 14. In the exemplary arrangement the bodies are attached through a threaded stud 32 that extends through the bodies of the microwave oven and the safe in an area that is not externally accessible. As represented in FIG. 6, the upper threaded portion of the stud 32 extends in an interior area 34 of the safe 16. A releasable fastener 36 which in this exemplary arrangement comprises a threaded nut is engaged with the threaded portion of the stud within the interior area. The releasable fastener 36 is only accessible within the interior area 34 of the safe such that the threadable fastener can only be disconnected when the safe is open. Such an arrangement reduces the risk of persons who do not have access to the safe attempting to disengage the safe from the rest of the appliance unit structure so as to abscond with the safe. Of course as can be appreciated multiple such studs and releasable fasteners may be utilized in exemplary arrangements to hold the safe in engagement with the rest of the appliance.

As represented in FIG. 2 the exemplary refrigerator 12 includes one or more anti-theft brackets 38. The exemplary anti-theft bracket 38 is a generally L-shaped bracket that is in fixed connection with the body of the refrigerator 12. The L-shaped bracket includes a plurality of apertures which are configured for accepting fasteners therethrough. The configuration of the exemplary anti-theft bracket enables fasteners to be connected through the apertures to adjacent surfaces such as a wall behind the appliance or the supporting floor structure or both. Fastening the refrigerator to an adjacent surface of a structure such as a wall or floor further reduces the risk that the appliance can be removed from its operative position for purposes of theft or vandalizing the appliance.

Further used to reduce the risk of theft or vandalism of the exemplary appliance 10 is the at least one safe circuit 24 as represented in FIG. 4. The at least one safe circuit is in operative connection with a battery 40. The exemplary safe circuit 24 is further in connection with a loud, audible enunciator 42. The audible enunciator 42 may in some embodiments include a piezoelectric alarm device which provides a loud audible signal to indicate tampering or an effort to gain access to the interior area of the safe.

The exemplary safe circuitry is further in operative connection with a plurality of sensors 44. In the exemplary arrangement safe sensors 44 are operative to sense one or more tamper conditions associated with the safe. In the exemplary arrangement the safe circuit is operative responsive to one or more of the sensors sensing a safe tamper condition to cause the audible enunciator 42 to provide a loud alarm signal to indicate tampering. Further because the safe circuitry can be operated by the battery 40, the enunciator of the exemplary arrangement will continue to provide an alarm even if the safe is separated from the power control circuitry 20. Further in exemplary embodiments the safe circuitry may be operative to cause the transmission of wire or wireless signals indicative of an alarm condition.

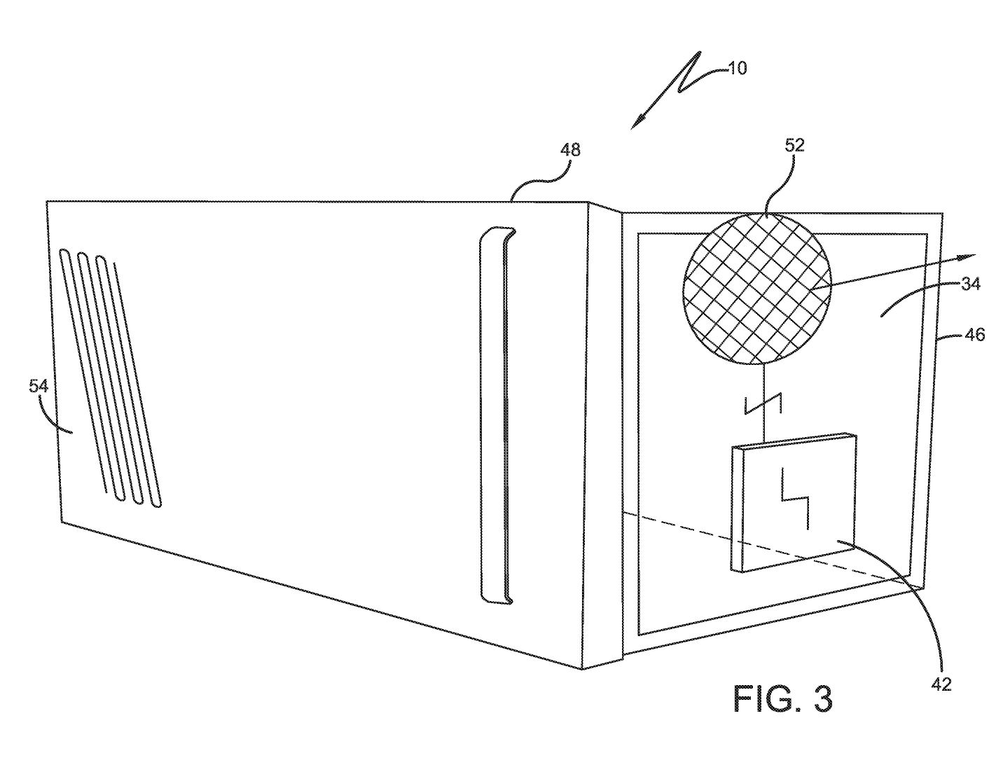

As represented in FIG. 3, the exemplary safe includes a safe body 46 which bounds the interior area 34 of the safe as previously discussed. The interior area includes a safe opening at a forward side thereof. A safe door 48 is movably mounted in supported connection with the safe body 46. The safe door is movable between an open position in which the interior area of the safe is accessible from outside the safe and a closed position in which the interior of the safe is inaccessible.

The safe further includes a lock 50 which is selectively operative to hold the safe door in the closed position. The exemplary lock 50 is an electrically actuated lock that is in operative connection with the at least one safe circuit 24 and is selectively changeable between locked and unlocked conditions in a manner that is later discussed in detail.

The exemplary sensors which sense tamper conditions of the safe include in the exemplary embodiment a material mesh schematically indicated 52 in FIG. 3. The material mesh 52 in the exemplary arrangement includes an electrically conductive material that extends adjacent to at least a portion of the interior area 34. In the exemplary arrangement the at least one safe circuit is operative to sense the change in integrity of the material mesh 52 which may indicate that the body of the safe is being drilled or otherwise being compromised. Such a compromise may cause a change in inductance, capacitance, conductance, impedance or other properties of the material mesh which is detectable by the safe circuitry. The safe circuitry then operates to cause the audible enunciator to provide an alarm.

Another safe sensor of an exemplary embodiment includes a conductive trace 54. The conductive trace which is shown schematically in FIG. 3 is an electrically conductive path which may extend inside or within the walls or the door bounding the interior area. The conductive trace is in operative connection with the safe circuitry. A break in continuity of the conductive trace may be indicative of cutting, drilling or other activity which corresponds to an effort to compromise the safe. In the exemplary arrangement the safe circuitry is operative to detect a break in electrical continuity of the conductive trace and to cause the alarm enunciator to give an alarm in response thereto. Further it should be understood that one or more conductive traces may also be positioned on or in connection with mounting brackets, fasteners or other items which are utilized to hold the safe in connection with the microwave or other structures. Such conductive traces may also be monitored through operation of the safe circuitry to detect detachment or other conditions which may correspond to an attempt to compromise the safe and to give one or more alarm signals in response thereto.

Further in other exemplary arrangements the sensors in operative connection with the safe circuitry may include a position sensor. A position sensor may include, for example, a contact sensor or switch that is positioned to detect relative displacement which represents relative movement of the safe. Such relative displacement may be detected with respect to the underlying unit structure such as the microwave or refrigerator. Alternatively or in addition, such relative displacement may be relative movement with respect to other fixed points within the environment in which the safe is mounted. In exemplary arrangements, relative displacement of the safe body is operative to cause a change in condition of the position sensor. The change in condition of the sensor is detected through operation of the safe circuitry which causes the alarm enunciator to give an alarm in response thereto. In other arrangements the position sensor may be operative to sense movement of the safe door relative to the safe body when the lock is in the locked condition. This may be indicative of an attack on the safe door. Alarms can be given remotely to monitoring stations in addition or as an alternative to the audible alarm. Of course it should be understood that these approaches and sensing devices are exemplary and in other embodiments other approaches may be used.

In the exemplary arrangement of appliance 10, the microwave oven portion includes at least one user input device 56. In the exemplary arrangement the at least one user input device 56 may include manually actuatable buttons, knobs, switches, wireless portals or other suitable input devices through which user inputs may be received. Such user input devices of the exemplary arrangement are operative to control the microwave oven 16 for purposes of cooking and heating items that are held therein. Further in the exemplary arrangement, the at least one user input devices 56 is operable to provide inputs for purposes of controlling the locked and unlocked condition of the safe 16. In an exemplary arrangement a user is enabled to provide one or more inputs to indicate that they wish to change the safe from the locked condition to an unlocked condition. Responsive to such an input, the associated circuitry, which in the exemplary embodiment is included in the power control circuitry 20, is operative to prompt the user through an output device such as a display 58, to provide inputs through the input devices 56 which correspond to a combination or other appropriate inputs that the circuitry recognizes as appropriate to change the condition of the lock. Responsive to the receipt of such inputs through the at least one input device 56, the circuitry 20 is operative to communicate with the safe circuitry 24 so as to change the condition of lock 50 from the locked condition to the unlocked condition, for example. In response to receipt of these signals, the lock 50 is operative to change to the unlocked condition and enable the door 48 to be opened. In this condition a user is enabled to access the contents of the interior area 34 of the safe.

In some exemplary embodiments the power control circuitry 20 and/or safe circuitry 24 is operative to enable a user to provide inputs so as to change the combination that will open the safe when the safe is in the unlocked condition. Such approaches may be useful when the appliance 10 is used in an environment such as a hotel where each guest may wish to utilize the safe with a different combination. The exemplary circuitry is operative to provide a user with outputs such as through the display 58 or other output device, so as to prompt a user to provide particular inputs through the at least one input device 56 if they wish to change the combination for the safe. Responsive to receiving such an input, the exemplary circuitry is operative to further prompt the user through the display to input certain digits or other values that will make up the new combination for opening the safe. The user is then enabled to input such values through the at least one input device 56 of the microwave oven so as to program the circuitry to enable unlocking the safe in response to the input of such combination in the future. Thereafter the user may store items within the interior area of the safe, and close the door thereof which is operative to change the lock 50 to the locked condition. The user can thereafter access the safe by providing appropriate inputs through the at least one input device. Of course this approach is exemplary and in other embodiments, other approaches may be used.

Further exemplary circuitry used in connection with certain embodiments may enable authorized persons such as the proprietors of the hotel or other facility in which the appliance is located to unlock the safe in the event that the user forgets the combination or leaves the hotel with the safe in a locked condition. For example, exemplary circuitry may include programming to open the safe in response to a combination that is known only by the proprietor of the establishment in which the appliance is installed. Of course these approaches are exemplary and in other embodiments other approaches may be used.

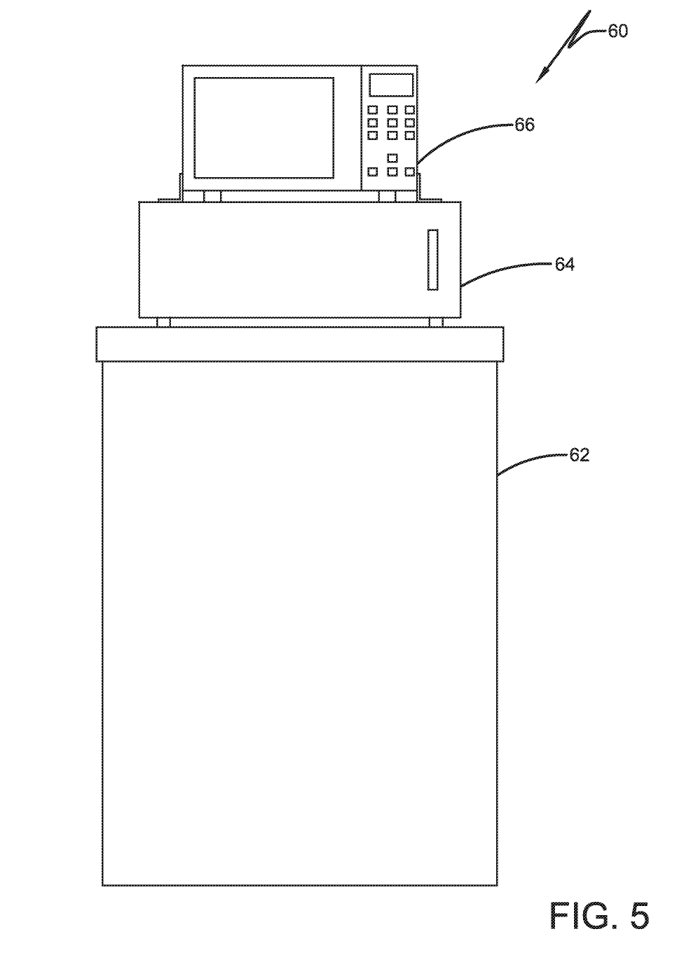

FIG. 5 shows an alternative exemplary arrangement of an appliance 60. Appliance 60 may include features similar to appliance 10 previously described. Appliance 60 is a unit which has the stacked configurations of the microwave oven and the safe reversed relative to appliance 10. Specifically in appliance 60 a refrigerator 62 directly supports a safe 64. The safe 64 directly supports the microwave oven 66. In this exemplary appliance 60, the microwave oven is positioned at a higher elevation so as to facilitate the use thereof relative to appliance 10. Further it should be understood that other exemplary arrangements may include different configurations. For example in some exemplary configurations, the safe may be positioned below the refrigerator portion so as to provide support thereto. Such an approach may be appropriate in some arrangements in which the safe portion may be constructed of very heavy materials which are not ideally supported by the relatively lighter weight body of the refrigerator. Further in such arrangements anti-theft brackets to adjacent surfaces such as floors and walls may be attached at the lowest level directly to the safe. Alternatively or in addition, anchor straps, cables or other suitable anchors may also be attached between the safe body and adjacent structures so as to reduce the risk of the safe being moved.

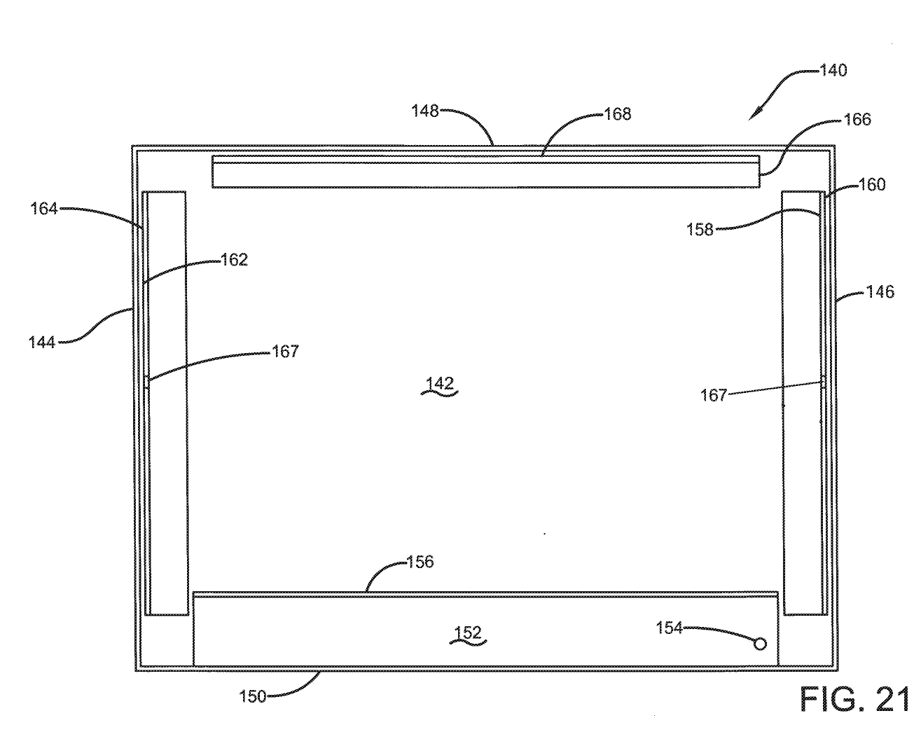

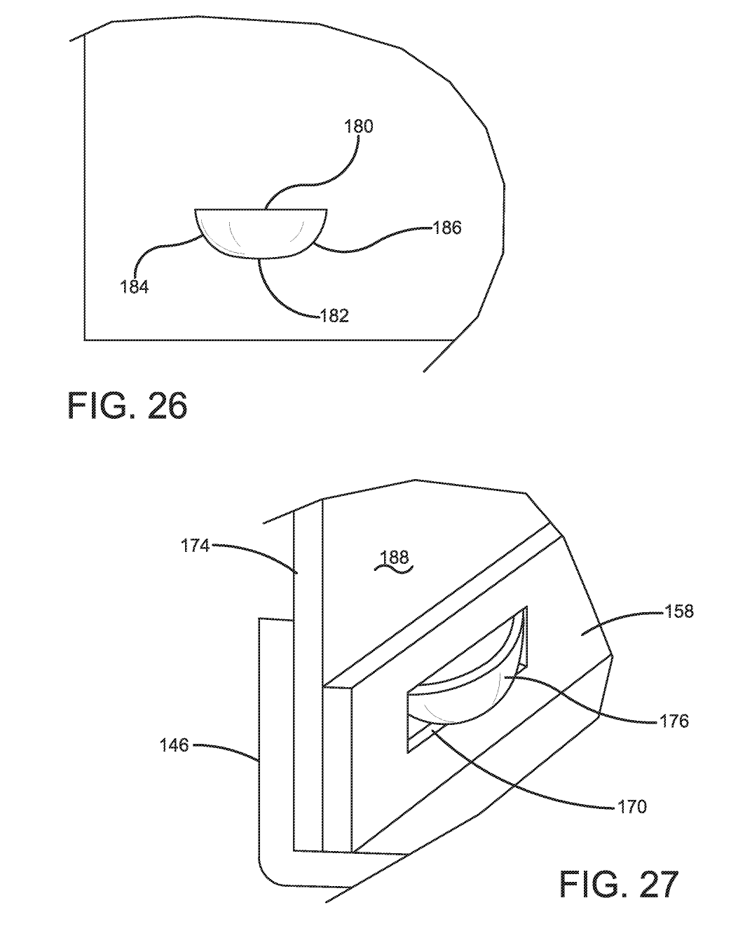

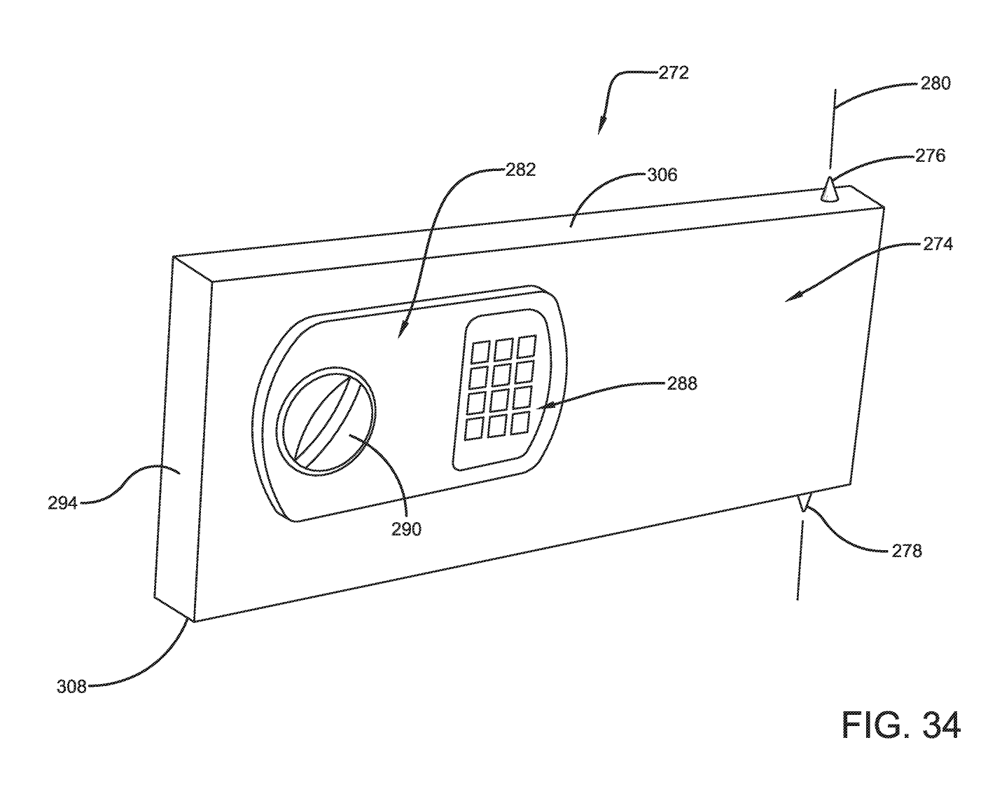

FIGS. 21-37 show an alternative arrangement of a safe construction which is suitable for use with safes of the exemplary appliance, in other devices or in a standalone arrangement. The safe configuration shown has the capability of being stored and shipped as a plurality of flat stacked wall components. The components can be transported in a disassembled condition in a compact package. At a point of assembly, the components can be connected to form the safe by manual engagement and without hand tools or in some situations with the minimal use of hand tools. The exemplary arrangement further provides that once the components are engaged to form the safe, the components are securely engaged to provide resistance to intrusion into the interior area of the safe.

The exemplary alternative construction includes a plurality of wall pieces. The wall pieces include a bottom wall piece, a top wall piece, a pair of side wall pieces and a back wall piece. The exemplary construction further includes a door which can be releasably engaged with the wall pieces and which includes a lock which enables securing the interior area of a container body formed by the wall pieces.

FIG. 21 shows a top plan view of a bottom wall piece 140. The bottom wall piece includes a bottom plate 142. The bottom wall piece 140 further includes an outer bounding side wall segment 144. The outer bounding side wall segment 144 extends generally perpendicular to the bottom plate 142. An outer bounding side wall segment 146 extends on an opposed side of the bottom wall piece from side wall segment 144.

The bottom wall piece 140 further includes an outer bounding back wall segment 148. The back wall segment 148 extends generally perpendicular to the side wall segments 144 and 146. A front wall segment 150 extends on the bottom wall piece at a side opposite back wall segment 148. A bottom shelf 152 extends inward from the front wall segment 150. The bottom shelf 152 includes a bottom hinge pin opening 154 therein. The bottom shelf 152 further includes a bottom turned edge 156. The bottom turned edge 156 as later explained serves as an upward extending stop for the safe door when in the closed position. In the exemplary arrangement, the bottom turned edge extends generally the entire width of the bottom shelf 152 which is later described generally corresponds to the entire width of the access opening to the interior area of the safe.

The exemplary bottom wall piece includes an upward engaging side wall segment 158. In the exemplary arrangement, the engaging side wall segment includes a leg of an angle piece that is fastened to the bottom plate 142. The engaging side wall segment 158 is disposed inwardly from the adjacent outer bounding side wall segment and defines an elongated side slot 160 therebetween. An engaging side wall segment 162 extends adjacent to outer bounding side wall segment 144 so as to define an elongated side slot 164 at the opposite side of the bottom wall piece from side slot 160.

An engaging back wall segment 166 is disposed inwardly and adjacent to outer bounding back wall segment 148. Back wall segment 148 and engaging wall segment 166 define a back slot 168.

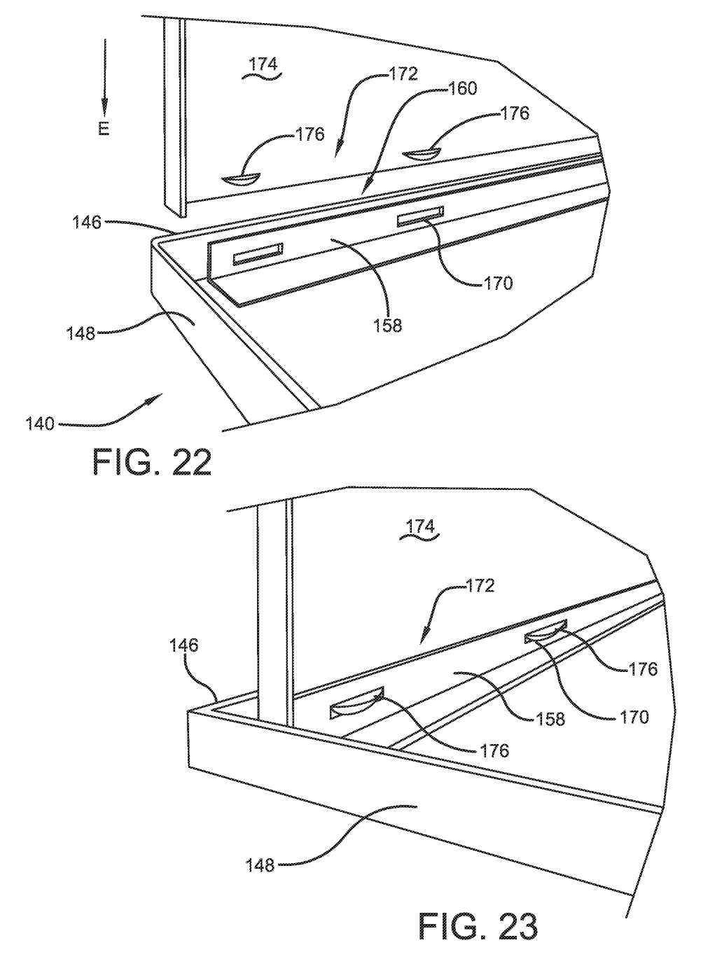

In an exemplary embodiment each of the engaging wall segments include recesses 170 as shown in FIG. 23. The side wall pieces as later discussed each include a latching edge portion 172 at both the top and the bottom of the side wall piece. Only the latching edge portion at the bottom of the hinge side piece 174 is shown in FIG. 22. The latching edge portion 172 is configured to be engaged in an elongated slot such as side slot 160 shown in FIG. 22.

In the exemplary embodiment, the side wall pieces such as side wall piece 174 include a plurality of tabs 176 thereon. The positions of the tabs correspond to the positions of the recesses of the engaging wall segment when the pieces are assembled.

In the exemplary embodiment, the bottom wall piece includes apertures 167 that extend through each of engaging side wall segments 158 and 162. In the exemplary arrangement, the apertures 167 are configured for receiving a respective releasable fastener. The releasable fasteners are used to further hold side wall pieces in engagement with the bottom wall piece as later described in detail.

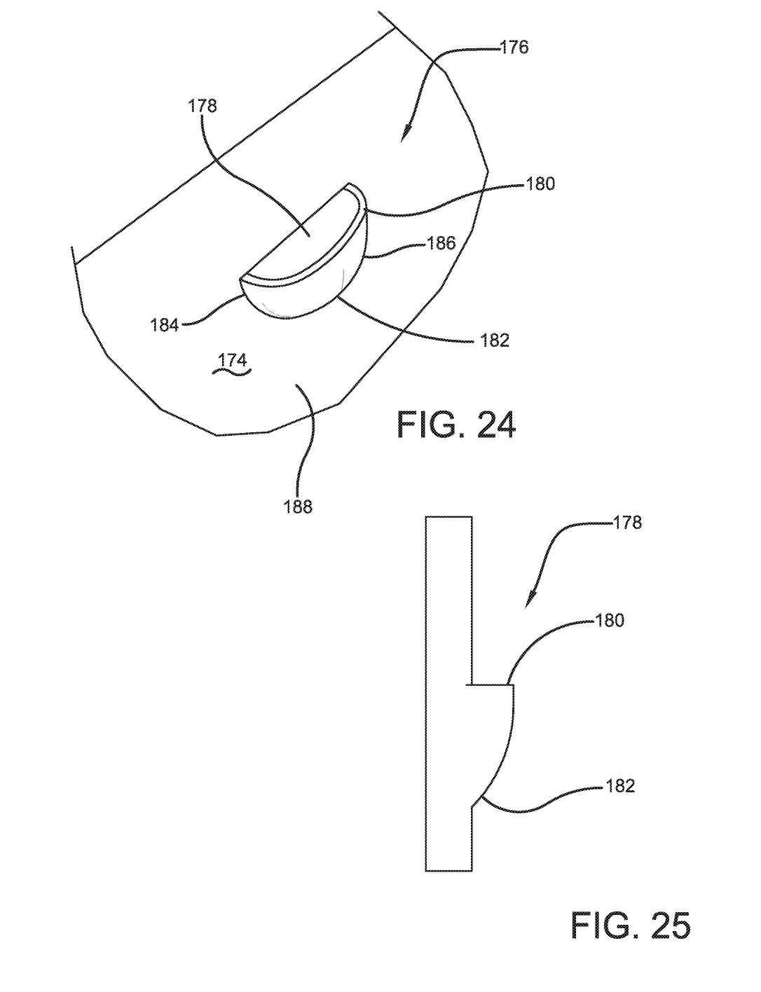

The exemplary tab 176 comprises a punched opening in the latching edge portion of the planar wall portion of the side wall piece. As shown in FIGS. 24-26, tabs 176 of an exemplary embodiment include an opening 178 that extends generally perpendicular to the planar wall of the side wall piece 174. The exemplary tab includes a catch surface 180 at a first end that is sheared and disposed away from the surrounding planar wall surface.

The exemplary tab 176 further includes a smooth rounded second end 182 opposite of the catch surface 180. The tabs 176 further include smooth rounded sides 184 and 186. The smooth second end and rounded sides of the exemplary tab are continuous with the adjacent wall surface such as the inner surface 188 of side wall piece 174.

In the exemplary arrangement, the engagement of the bottom wall piece 140 and side wall piece 174 is accomplished by moving the side wall piece 174 in the direction of Arrow E relative to the bottom wall piece 140. This causes the tabs to deform and deform the engaging wall segment until the tabs move into the slot 160 and into the recesses 170 of the engaging wall segment 158. Such engagement is represented in FIGS. 23 and 27. Once the tabs are in engagement with the recesses, the bottom wall piece and side wall piece return to the undeformed configurations and are in firmly fixed engagement as the catch surface 180 is in abutting relation with the adjacent surface bounding the recess. This securely engages the pieces together and reduces the risk of the pieces being separated by prying or other attack methods.

While in the exemplary embodiment, the latching edge portions which extend in the slots include the tabs and the engaging side wall segments include recesses for engaging the tabs, in other arrangements, this configuration may be reversed. For example, the engaging side wall segments may include tabs which engage recesses in the latching edge portions of the adjacent wall pieces. Alternatively each piece may include some tabs and some recesses which engage when the pieces are assembled. Of course it should be understood that the configuration of the exemplary tabs and recesses are exemplary of interengaging projections and recesses that may be used.

Further, while the exemplary arrangement is configured to enable assembly through manual engagement of wall pieces either without tools or with minimal use of tools, other arrangements utilizing similar principles may utilize conventional fasteners or other devices for holding wall pieces in engagement. It will be appreciated that numerous different engaging configurations may be utilized along with the principles that are described herein.

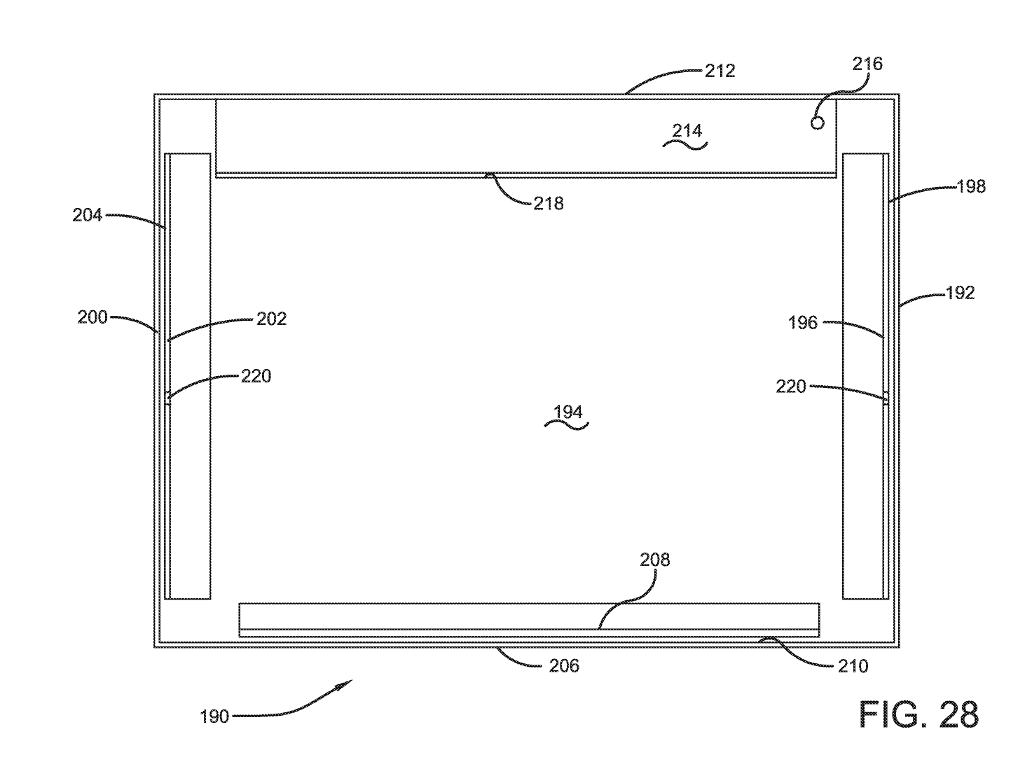

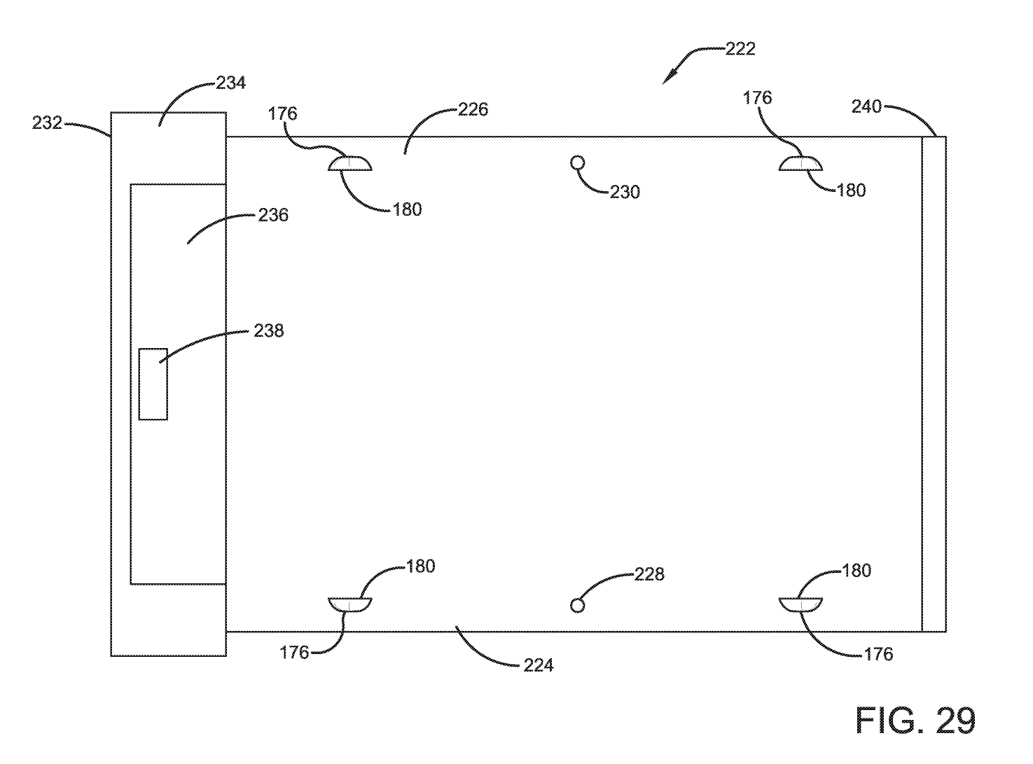

In an exemplary safe having the alternative construction described herein, the safe includes a top wall piece 190 shown in FIG. 28. In the exemplary embodiment, the top wall piece 190 is generally the mirror image of bottom wall piece 140. The top wall piece 190 includes outer top bounding wall side segment 192 which is turned generally perpendicular to a top plate 194. An engaging side wall segment 196 is disposed adjacent to wall segment 192 and defines a top side slot 198. Similarly, top wall piece 190 has a bounding top side wall segment 200 at a side opposite top side wall segment 192. An engaging side wall segment 202 is adjacent to top side wall segment 200 and defines a top side slot 204.

Top wall piece 190 further includes a bounding top back wall segment 206. An engaging back wall segment 208 is adjacent to segment 206 and defines a back top slot 210.

Similar to bottom wall piece 140, top wall piece 190 includes a front wall segment 212 that in the assembled condition of the safe extends downward from the top plate 194 and bounds the access opening to the interior area of the safe. A top shelf 214 extends inward from the front wall segment 212 and includes a top hinge pin opening 216. Top hinge pin opening 216 is configured to accept a hinge pin therein associated with the safe door as later described. The exemplary top shelf 214 includes a top turned edge 218. The top turned edge extends perpendicular to the shelf 214 and provides a downward extending stop. The downward extending stop engages the safe door in a closed position and prevents the safe door from moving further into the interior area of the safe beyond the closed position. In the exemplary embodiment, the top turned edge 218 extends substantially the entire width of the access opening into the interior area of the safe.

Similar to bottom wall piece 140, the top wall piece 190 includes apertures 220 that extend in each of engaging side wall segments 196 and 202. Apertures 220 are configured to receive releasable fasteners therein to further engage the top wall piece with side wall pieces of the safe. Of course it should be understood that these configurations are exemplary and in other embodiments, other approaches may be used.

FIG. 29 shows an exemplary side wall piece 222. Side wall piece 222 is a strike side wall of the exemplary safe construction which includes the strike that engages the bolt of the safe door to hold the safe door in a closed position.

The exemplary side wall piece 222 includes a bottom latching edge portion 224. The bottom latching edge portion 224 is configured to engage in side slot 164 of the bottom wall piece 140. The bottom latching edge portion 224 includes tabs 176. The tabs 176 have their catch surfaces 180 facing away from the bottom edge portion 224.

Side wall piece 222 further includes a top latching edge portion 226. The top latching edge portion 226 is configured to extend in top side slot 204 of top wall piece 190. The top latching edge portion 226 includes tabs 176 as shown with the catch surfaces 180 thereof facing downward as shown when the safe is assembled. Side wall piece 222 further includes apertures 228, 230 in the latching edge portions 224 and 226 respectively. Apertures 228 and 230 are used in an exemplary embodiment to hold the wall pieces in engaged relation once the wall pieces have been assembled.

Side wall piece 222 further includes a front facing portion 232. Front facing portion 232 in the assembled condition of the safe bounds the side of the access opening. An inward extending portion 234 extends inward from the front facing portion. The inward extending portion extends inward toward the interior area of the safe and has a configuration that reduces the risk that prying tools can be extended behind the safe door when the door is in a closed position.

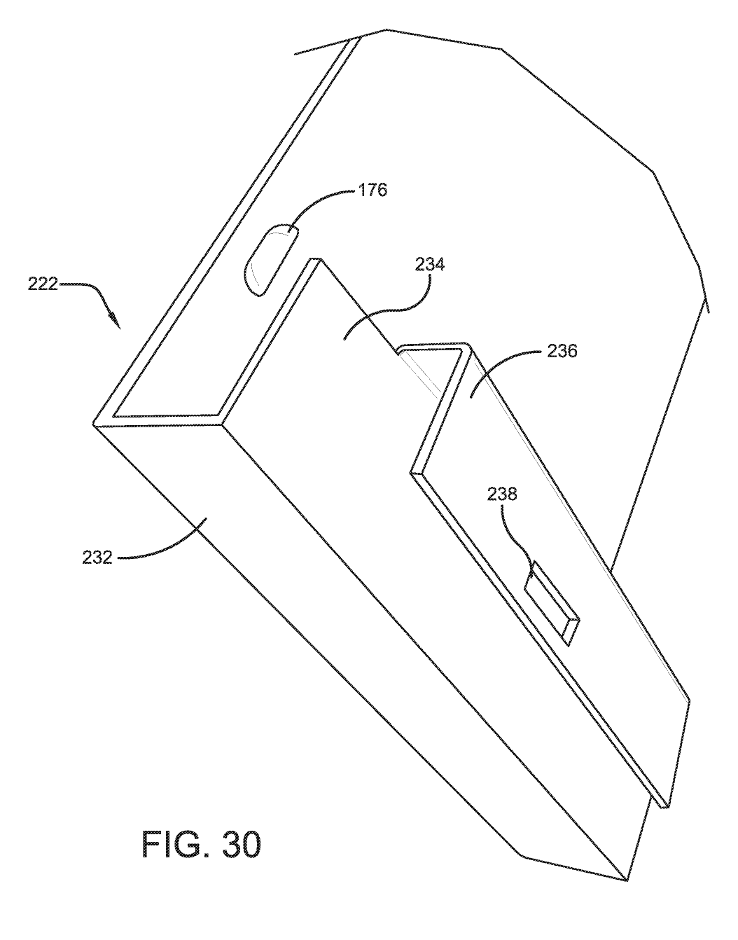

As shown in FIG. 30, an L-shaped strike 236 extends from the inward extending portion. The strike 236 includes a forward extending portion that is disposed sideways from and generally parallel to the inward extending portion 234. The strike 236 includes a strike opening 238. As later explained in detail, the strike opening 238 is sized to accept a retractable bolt associated with a lock of the door of the safe. When the bolt is in extended engagement with the strike opening 238, the safe door is held secured in a closed position.

The exemplary side wall piece 222 further includes an inturned back portion 240. The inturned back portion serves to close the back side of the safe enclosure and mate in abutting relation with a back wall piece in a manner later described.

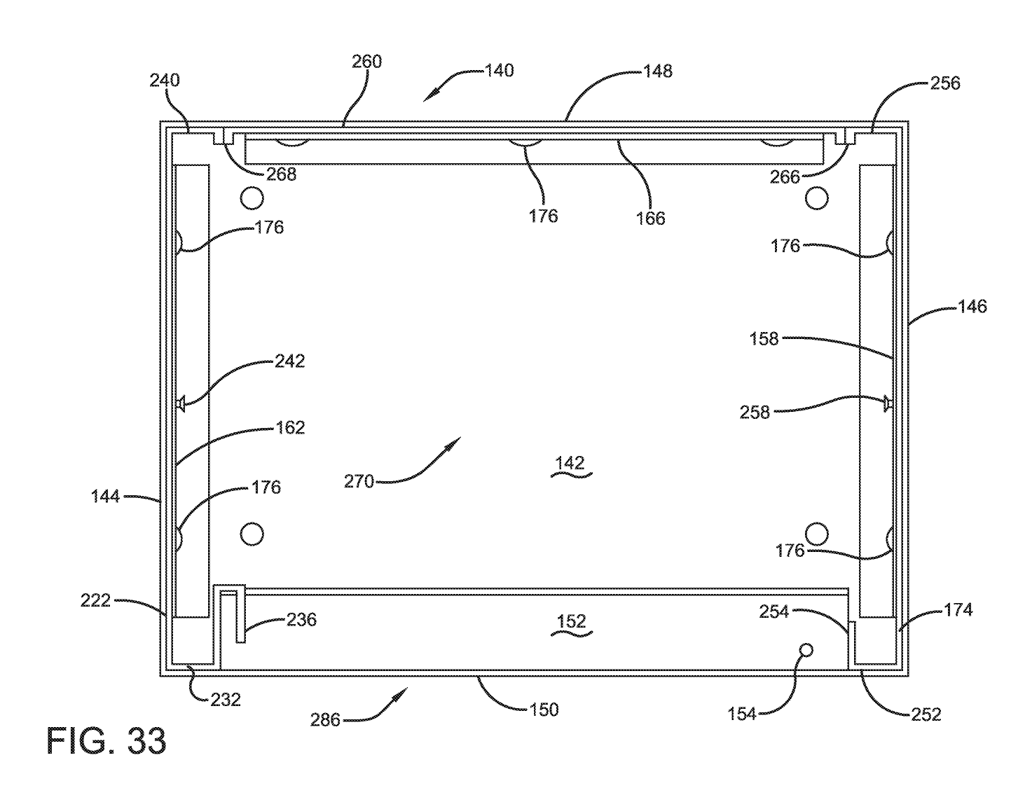

FIG. 33 shows a top plan view of the bottom wall piece 140 in engaged relation with the side wall piece 222. As shown in the assembled position, the tabs 176 on the lower latching edge portion 224 extend in engaged relation with the recesses on engaging side wall segment 162. Also as shown in FIG. 33, a releasable fastener 242 extends in aperture 228 of side wall piece 222 and aperture 167 of engaging side wall segment 162. In the exemplary arrangement, the releasable fastener 242 may include a pin or screw which extends in the apertures. By extending in the apertures, the releasable fastener provides further engagement and resistance to separation of the bottom wall piece 140 and the side wall piece 222. Of course this construction is exemplary and in other embodiments, other approaches may be used.

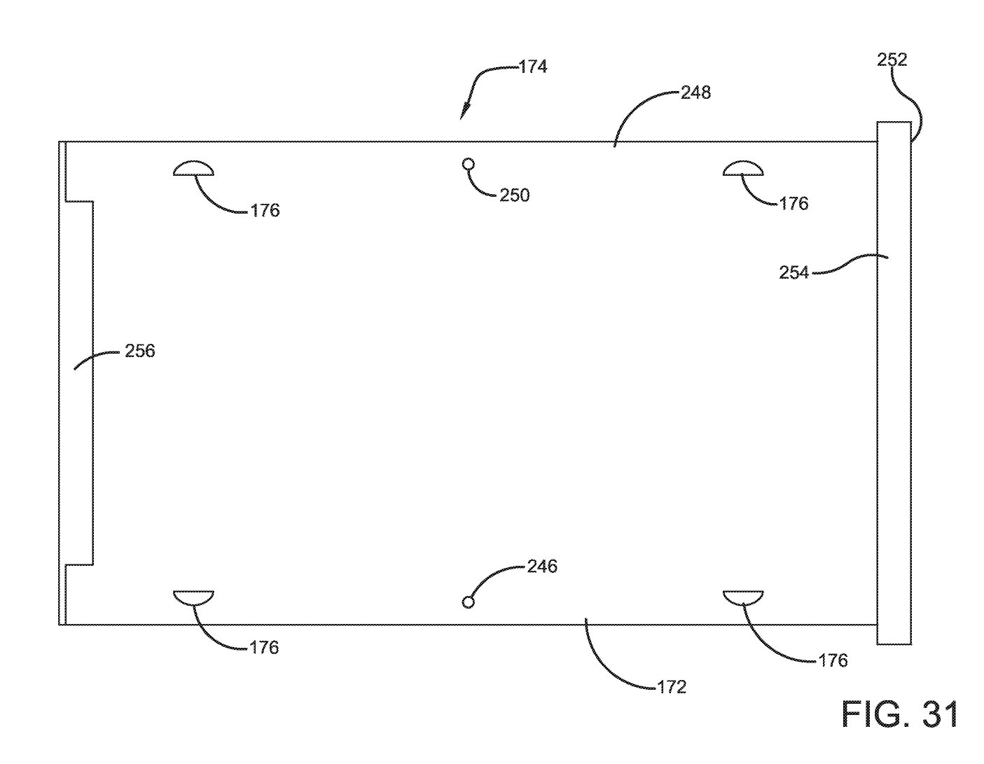

FIG. 31 shows side wall piece 174 in greater detail. Side wall piece 174 of the exemplary embodiment extends on the hinge side of the safe opposite to strike side wall piece 222.

Side wall piece 174 includes a bottom latching edge portion 172 which is configured to extend in side slot 160 of the bottom wall piece. Latching edge portion 172 includes tabs 176 which are configured in a manner similar to that previously described. The bottom latching edge portion 172 further includes an aperture 246. Aperture 246 is configured to be aligned with aperture 167 in engaging side wall segment 158 when in the assembled condition.

Side wall piece 174 further includes an upper latching edge portion 248. Upper latching edge portion 248 is configured to engage top side slot 198 in top wall piece 190. Upper latching edge portion 248 further includes tabs 176 for engaging the recesses in engaging side wall segment 196. Upper latching edge portion 248 further includes an aperture 250. Aperture 250 is configured to be aligned with aperture 220 in engaging side wall segment 196 when in the assembled condition therewith.

Side wall piece 174 further includes a front facing portion 252. As shown in FIG. 33, the front facing portion 252 faces forward on the container body when the safe is assembled. Front facing portion 252 also bounds the side of the access opening to the interior area of the safe. Side wall piece 174 further includes an inturned portion 254. The inturned portion 254 extends parallel to the main portion of side wall piece 174. Inturned portion 254 extends inward toward the interior area of the container body. In the assembled condition of the container body of the safe, the inturned portion 254 serves to help prevent access to the interior area of the safe via pry bars or other burglary tools when the safe door is closed.

Side wall piece 174 further includes an inturned back portion 256. Inturned back portion 256 closes the back corner of the container body on the side where the side wall piece 174 is positioned. The inturned back portion further includes a leg which is turned back toward the interior area and which is in abutting relation with a back wall piece in the assembled condition of the safe. Of course this configuration is exemplary and in other embodiments, other approaches may be used.

As shown in FIG. 33, a releasable fastener 258 extends in aperture 167 of engaging side wall segment 158 and aperture 246 of side wall piece 174. The fastener further helps to hold the bottom wall piece 140 and the side wall piece 174 in engagement once they have been assembled. The releasable fastener 258 may include a pin, screw or other suitable member for extending between the apertures and preventing relative movement thereof.

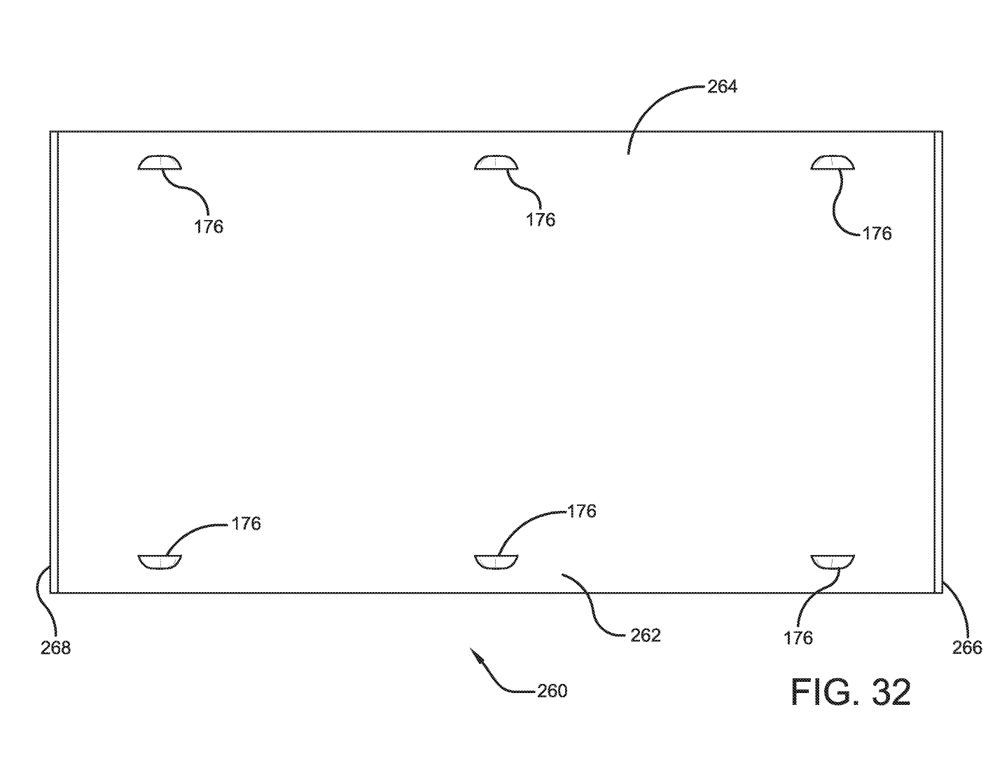

The exemplary safe further includes a back wall piece 260 which is shown in FIG. 32. The exemplary back wall piece 260 includes a lower latching edge portion 262 and an upper latching edge portion 264. Each of the lower and upper latching edge portions include tabs of the type previously described. Once the upper latching edge portion 264 is extended in the back top slot when the safe is assembled, the tabs in the upper latching edge portions extend in recesses in the engaging back wall segment 208. Similarly as represented in FIG. 33, the lower latching edge portion 262 extends in back slot 168 and the tabs 176 thereon extend through the recesses in the engaging back wall segment 166.

The exemplary back wall piece 260 includes inturned portions 266 and 268. Inturned portion 268 abuts inturned back portion 240 of side wall piece 222 in the assembled condition as shown in FIG. 33. Similarly inturned portion 266 is in abutting relation with inturned back portion 256 of side wall piece 174. In some exemplary embodiments, the inturned portions 266 and 268 may be connected to the adjacent wall portions by fasteners, clips or similar holding mechanisms which are accessible and installed in the interior area 270 of the container body. By holding the inturned portions in engaged relation with the adjacent wall portions, the risks for compromise the container body of the safe is reduced. Of course these approaches are exemplary and in other embodiments, other approaches may be used.

The exemplary embodiment of the safe includes a door 272. The door 272 is sized for closing the access opening to the safe which extends between the front facing portion 232 of side wall piece 222 and front facing portion 272 of side wall piece 174. The access opening is also bounded at the top by front wall segment 212 and at the bottom by front wall segment 150. The door further includes a front face 274 which faces outward when the door is in a closing position, in which the door closes the access opening.

The door includes a top hinge pin 276 and a bottom hinge pin 278. The hinge pins extend along a common axis 280. In the exemplary embodiment, bottom hinge pin 278 is configured to be in operatively engaged relation in bottom hinge pin opening 154. The top hinge pin 276 is configured to be engaged in top hinge pin opening 216. As later discussed, the hinge pins of the exemplary embodiment are configured to be retractable to facilitate installing and removing the door from the assembled container body of the safe.

The exemplary door includes a user interface 282. The user interface 282 is in operative connection with a lock 284 which is selectively changeable between locked and unlocked conditions. In the locked condition of the lock 284, the door is positioned to block the access opening 286 to the interior area 270. The exemplary user interface 282 is shown with an input device 288 and a manually turnable knob 290. In the exemplary embodiment, the user interface 282 shown is configured to enable a user to input a combination or similar code through the input device 288 and then to change the condition of the lock from a locked to an unlocked condition by turning the knob to 90. Of course other embodiments may be operative in a manner similar to that previously described where inputs through a user interface of the microwave oven or other input device of the appliance may be usable to change the condition of the safe lock. For example, in some embodiments the user interface may be suitable for programming combinations as well. This may enable the exemplary safe to be positioned and used separate from combination appliances such as those previously described.

Alternatively or in addition, multiple safes may be configured in adjacent or stacked relation so that different users may personally utilize adjacent safes to store personal belongings therein while excluding others from accessing the contents of the safe. This may be done, for example, in situations where multiple individuals share a common living or working space and each requires their own separate safe for storing their personal valuable possessions. For example, in some dormitory environments where a combined appliance including a compact refrigerator and microwave is utilized, two or more safes of the exemplary embodiment may be positioned in intermediate stacked relation between the refrigerator component and microwave oven component. Of course these approaches are exemplary and in other embodiments, other approaches may be used.

The user interface 282 utilized on an exemplary embodiment may further include other or additional features for purposes of locking and unlocking the safe. For example, in some exemplary embodiments the user interface may include an output device such as a display screen. The display screen may be suitable for providing the user with instructions for unlocking the door of the safe, programming a new combination or other suitable instructions for operation of the safe.

In other embodiments, the exemplary user interface may include other or different input devices such as, for example, a fingerprint reader. A fingerprint reader may be utilized to identify the fingerprint of a user that is authorized to access the interior area of the safe. In other embodiments, other types of biometric input devices may be utilized for purposes of providing access to the safe. Further it should be understood that some exemplary embodiments may include other features that have been previously described herein as usable to help secure the interior area of a safe from unauthorized access.

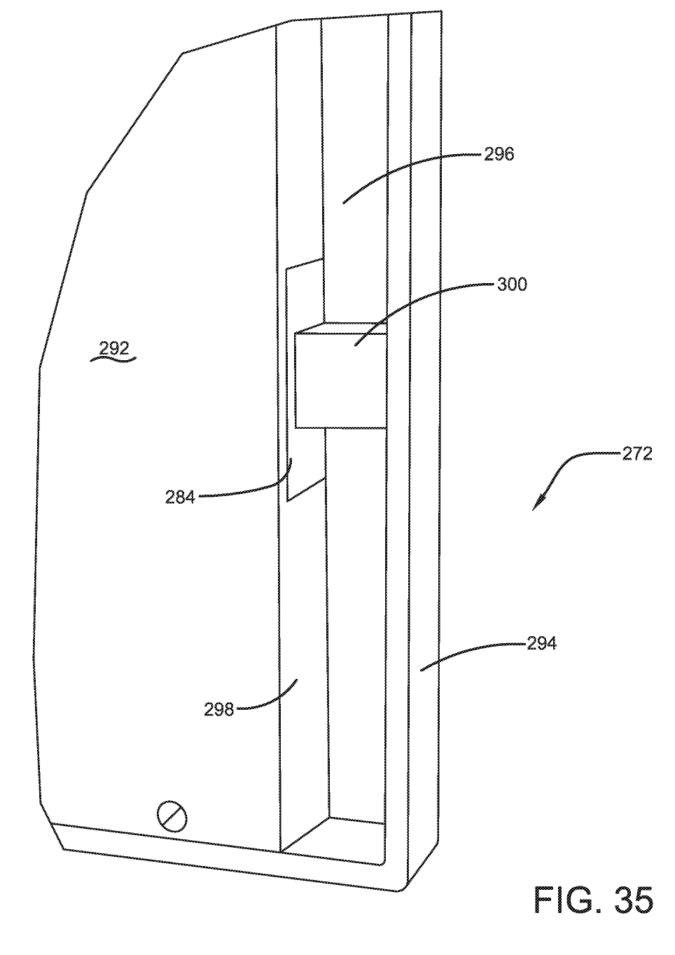

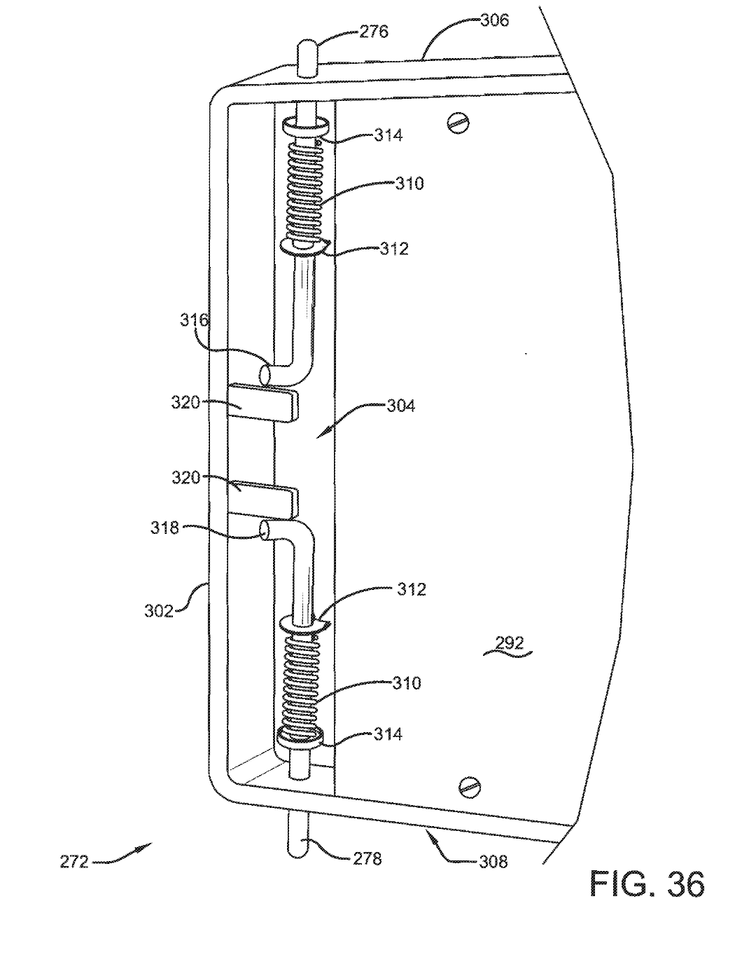

FIG. 35 shows a portion of the rear of the door 272. In FIG. 35, the side of the door adjacent the strike is shown. The door 272 includes an inner door face 292. Inner door face 292 includes a removable cover so as to facilitate housing the lock and other components within the door. Door 272 further includes an inturned end portion 294. End portion 294 extends perpendicular to front face 274. A strike recess 296 extends in the door inner face between the inner surface of end portion 294 and the face of lock 284 and a bounding wall 298 adjacent thereto.

The lock includes a retractable bolt 300. Bolt 300 is configured to engage the strike opening 238 in the strike 236 when the bolt is in an extended position and the door is closed. This corresponds to a locked condition of the lock.

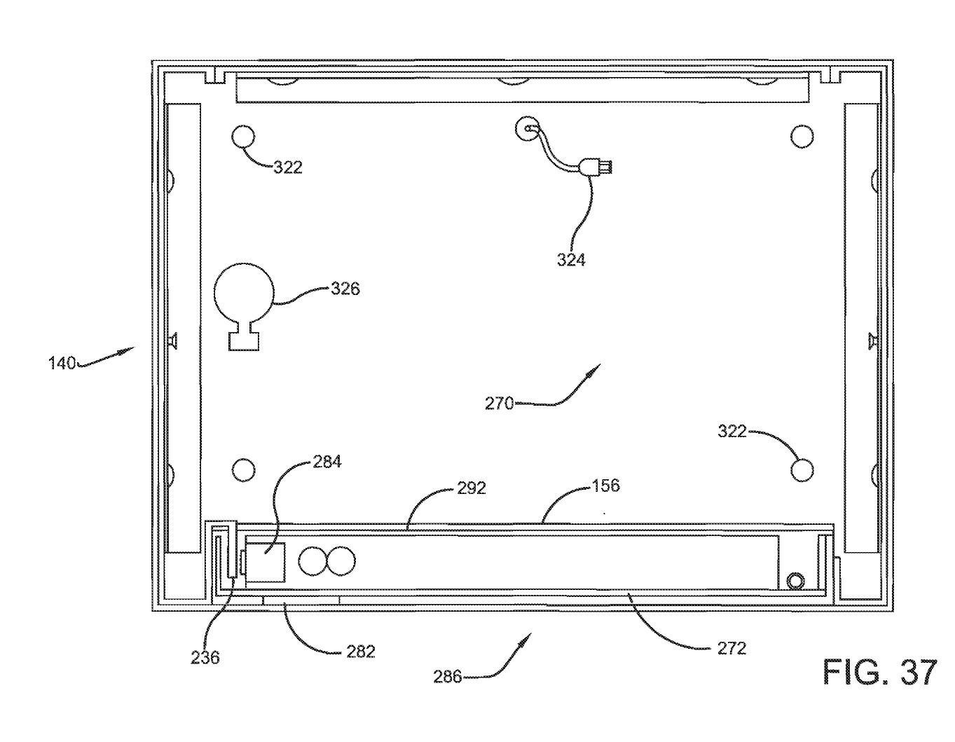

When the lock is unlocked, the bolt 300 is retracted to the left as shown in FIG. 35 into the body of the lock 284. This position also corresponds to the condition of the lock shown from above in the cross-sectional view of the door 272 shown in FIG. 37. With the bolt 300 retracted and disengaged from the strike 236, the door can be swung open rotating about the hinge pins and axis 280 so as to enable access to the interior area 270 of the safe through the access opening 286. To return the safe to the locked position, the door 272 is closed so as to be in a position to block the access opening 286. The condition of the lock is then changed via inputs through the user interface 282 or otherwise and the knob is turned so as to extend the bolt 300 into engaging relation with the strike opening 238. In this locked condition, the door 272 is held in the closed position.

The exemplary configuration of the lock, door and bolt the strike 236 positioned within the strike recess 296 when the door is closed. In this configuration access to the strike is blocked by the end portion 294, and the ability to compromise the door through the use of saws and other criminal tools is reduced. Of course it should be understood that this configuration is exemplary and in other embodiments, other types of lock, door, strike and latching configurations may be used.

FIG. 36 shows the opposed end of the inner face of the door 272 from that shown in FIG. 35. FIG. 36 shows the hinge side of the door which includes the upper hinge pin 276 and the lower hinge pin 278.

Door 272 includes an end portion 302 adjacent the hinge side. The end portion 302 extends inward and generally perpendicular to the front face 274. A hinge pin recess 304 extends between the end portion 302 and a wall extending rearward to the inner door face 292.

The door 272 includes an inward extending top portion 306 and an inward extending bottom portion 308. Upper hinge pin 276 is axially movable in an opening that extends in top portion 306. Similarly bottom hinge pin 278 is axially movable in an opening that extends in bottom portion 308. Each of the hinge pins are biased outwardly from the door by respective springs 310. Springs 310 act between inward extending supports 312 and a outward extending land 314 on each hinge pin. In the exemplary arrangement, one side of each land 314 is in biased engagement with a respective spring. In exemplary arrangements, the opposite side of each land 314 can serve as a stop to limit the extent that the respective hinge pin extends outwardly beyond the respective top or bottom portion of the door. Of course this configuration is exemplary and in other arrangements, other approaches may be used.

Hinge pin 276 includes an inturned portion 316. Similarly hinge pin 278 includes an inturned portion 318. Each of the hinge pins may be selectively turned within the hinge pin recess so as to be engaged with a respective stop 320. Each stop 320 is configured to engage the inturned portion of a hinge pin and prevent inward movement of the hinge pin such as might occur during efforts to compromise the safe and remove the door. Each respective stop may include detents, recesses, fasteners or other suitable items for holding each hinge pin in engagement therewith.

In the exemplary arrangement, each of the hinge pins 276, 278 may be accessed and manually turned when the safe door 272 is open so as to disengage each hinge pin from its respective stop 320. With the turned portions 316, 318 disengaged from each respective stop 320, each of the hinge pins may be retracted in their respective opening. This enables the door to be separated from the respective pin engaging openings 154 and 216 in the bottom wall piece and the top wall piece. This enables removing and separating the door from the container body. This may be done, for example, to change the door or type of lock that is utilized in connection with the safe.

In addition, in exemplary arrangements the hinge pins 276 and 278 may be manually retracted by engagement therewith after the container body of the safe is assembled so as to install the door thereon. Once the hinge pins are positioned in alignment with the respective hinge engaging recesses, each of the hinge pins may then be extended. Once the hinge pins are extended, they may be held in position by turning the respective turned end of each so as to engage the respective stop. This feature may enable more ready installation and changing of the safe door. Of course it should be understood that this configuration is exemplary and in other arrangements, other approaches may be used.

As can be appreciated in FIG. 37, the bottom turned edge 156 of the bottom shelf 152 and the top turned edge 218 of the top shelf 214 of the exemplary arrangement serve as upward and downward extending stops respectively that prevent movement of the door 272 into the interior area 270 beyond that required to close the access opening 286. Both of the turned edge portions extend substantially the entire width of the access opening. As a result, the bottom portion 308 of the door is engageable at its inner side along a substantial portion of the bottom turned edge 156 when the door is closed. Likewise the inner face of the top portion 306 is engageable with a substantial portion of the top edge 218. This engagement with the surfaces which serve as a stop help to prevent the door 272 from being compromised by being pushed inward when the door is in the closed position. It should be understood that this stop configuration is exemplary and in other embodiments, other approaches may be used. Of course the safe container body is enclosed by attachment of the top wall piece to the side and back wall pieces shown in FIG. 37. The top wall piece is attached to the side and back wall pieces in a manner similar to the bottom wall piece.

FIG. 37 further shows the door in horizontal cross section. Additional components may be housed in the door 272 of the exemplary safe. Such components may include batteries, circuitry, sirens, sensors, transceivers or other suitable devices which are used in connection with operation of the safe. Further as represented in FIG. 37, fasteners 322 may be extended through openings of the bottom wall portion of the safe so as to engage the safe with the top wall of a refrigerator or other structure positioned below. As with the previously described embodiment, access to the fasteners is limited in the exemplary arrangement to persons who can access the interior area 270 of the safe. This further facilitates the security of the exemplary construction. As can be appreciated, similar fasteners may be extended through the upper wall portion so as to engage a structure located above. This may include, for example, the body of the microwave oven. Alternatively in other arrangements, the attaching fasteners may provide engagement with other structures such as another safe. Of course these approaches are exemplary and in other embodiments, other approaches may be used.

Additional features may be included in the interior of the exemplary safe. This may include, for example, suitable power connectors for personal items that a user wishes to store within the safe. This may include, for example, a power connector 324 for supplying power to a mobile device such as a smart phone, iPad or similar mobile device. Alternatively, a power connector 326 may be positioned on a wall of the safe. The power connector 326 may include an inductive power connector that enables charging the batteries of the device by placing the device in adjacent relation with the inductive coil of the power connector. Of course these approaches are exemplary and in other embodiments, other approaches may be used.

The exemplary safe construction facilitates the storage and shipment of the safe by providing a compact arrangement in which the wall pieces and door can be shipped flat to the point of assembly. The assembly of the exemplary arrangement can be made without the use of hand tools. The exemplary arrangement provides for assembly through manual engagement of the wall pieces and manual installation of the door. Further, once the wall pieces have been assembled, there is difficulty in compromising the integrity of the safe container body and the door. Of course alternative embodiments may use only portions of these features and may still benefit from one or more of the inventive principles described.

Alternatively or in addition, additional device functionality may be added to the exemplary appliance unit. For example in some exemplary arrangements a large display screen such as for displaying television programs may be incorporated into a forward facing surface of the refrigerator, safe or microwave oven component. Such a display surface may be utilized for displaying video or other television programming as may be selected by a user. In some such arrangements the user input devices associated with controlling the microwave and the safe may also be utilized in connection with controlling the display output of video signals. Of course as can be appreciated, a remote device may also be used for controlling such a display. The inclusion of circuitry suitable for displaying video and/or television programming in connection with an appliance may further be useful for purposes of conserving space in small spaces such as hotel rooms and dormitory rooms. Other exemplary arrangements may integrate other functional components, such as a coffee maker or a food processor. Further the exemplary power control circuitry may be useful in terms of minimizing power draw and avoiding excessive load conditions when multiple functions of the appliance are attempted to be operated at the same time and may also operate to protect the circuitry associated with the appliance from potentially damaging conditions. Of course these approaches are exemplary and in other arrangements other approaches may be used.

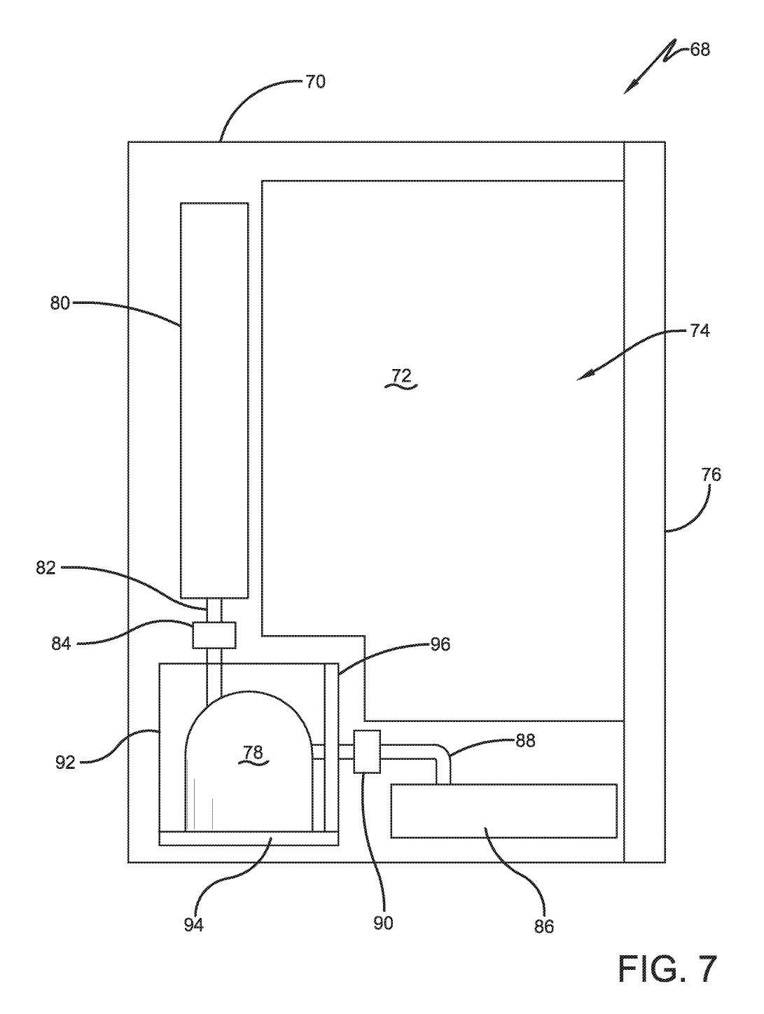

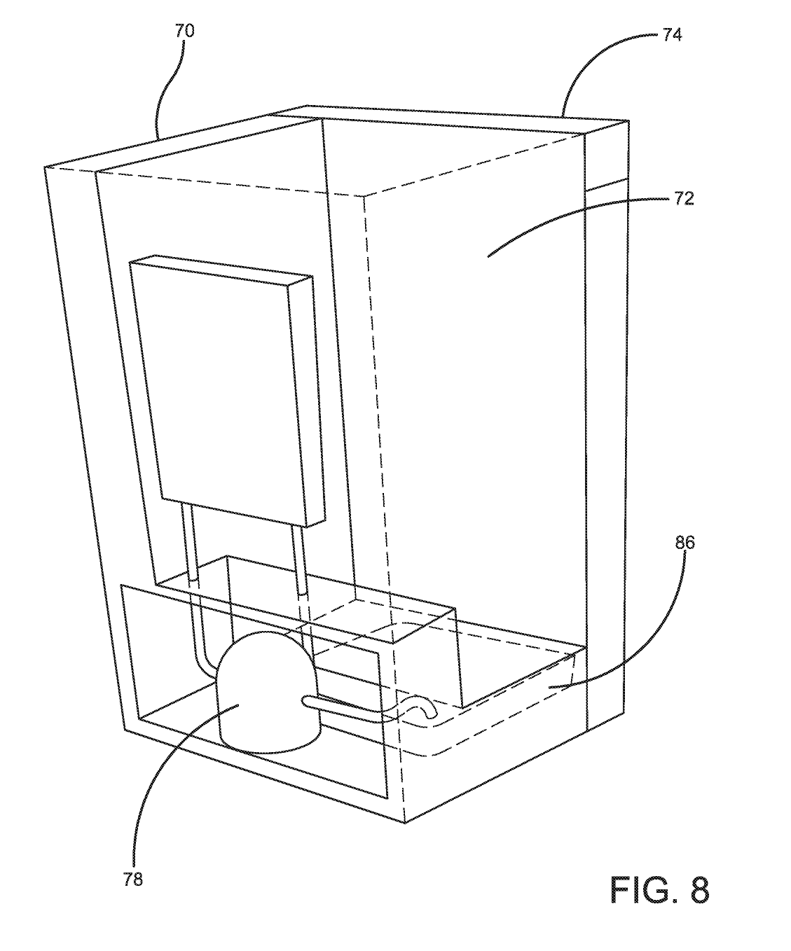

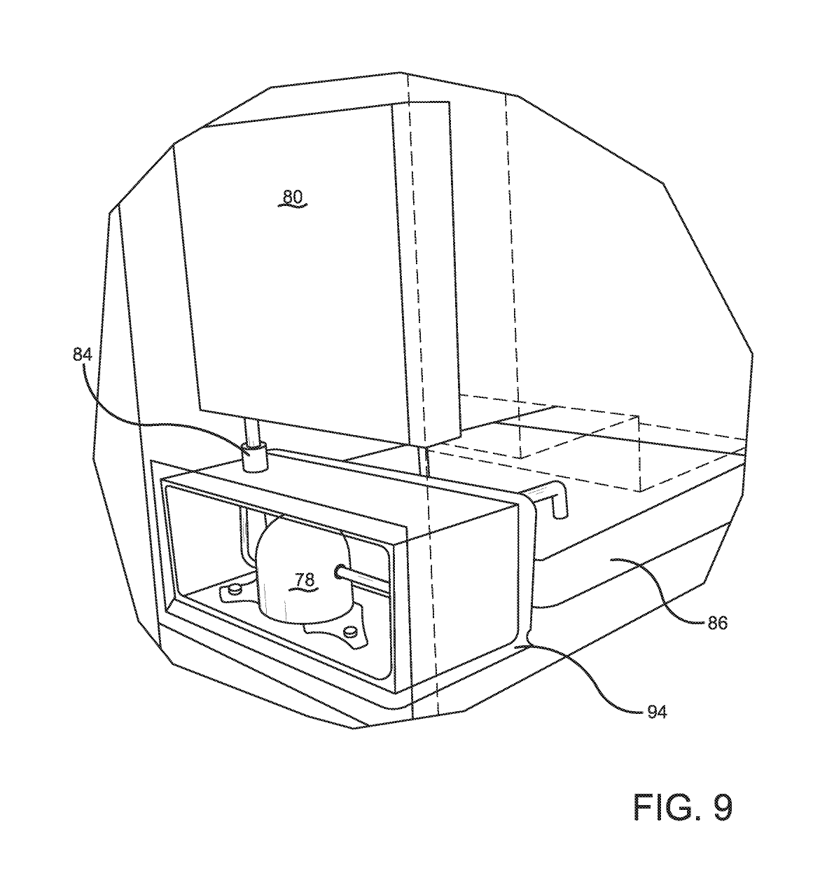

FIGS. 7-9 show schematically an exemplary arrangement that may be used in connection with a compact refrigerator or similar device. Such a compact refrigerator may be part of an appliance like that previously described or alternatively may be a standalone device. The exemplary embodiment described is utilized for purposes of minimizing vibration transmission which may occur as a result of operation of the refrigerant compressor used in connection with the refrigerator. Further the exemplary arrangement is operative to enable more readily repairing the refrigerator by having a removable compressor encasement structure which can be readily fluidly disconnected from components of the refrigerator, removed from the refrigerator body and replaced so as to minimize the repair time and cost associated repairs.

FIG. 7 shows a transparent side view of an exemplary refrigerator 68. Refrigerator 68 includes a body 70. Body 70 bounds an interior area 72 in which food or other items to be refrigerated are stored. Interior area 72 has an opening 74. A door 76 is movably mounted in operative connection with the body so as to enable selectively accessing and closing the opening to the interior area.

In the exemplary arrangement the refrigerator includes a compressor 78. The exemplary compressor 78 operates to compress and pump the refrigerant material so as to cool the interior area 72 and transfer the heat therefrom to the surroundings such as the air in the room in which the refrigerator is located.

In the exemplary arrangement the compressor 78 is in operative fluid connection with an evaporator 80. In the exemplary arrangement the evaporator is in or adjacent to the interior area 72 so as to remove heat therefrom. The expanded refrigerant within the evaporator is enabled to be in fluid connection with the compressor through a first fluid conduit 82. Fluid conduit 82 includes at least one disconnectable fluid loss preventing fitting 84. The exemplary fluid loss preventing fitting is operative to enable the first fluid conduit to fluidly be disconnected from the compressor 78 without significant loss of the refrigerant material. This may be accomplished in an exemplary arrangement through a pair of opposed check valves or a similar arrangement that prevents the loss of fluid from either the evaporator or the compressor when the fitting is disconnected. Alternatively other types of fluid loss prevention fittings may be utilized including those with valves which can be manually or automatically actuated therein so as to prevent fluid loss.

In the exemplary arrangement the compressor 78 is in fluid connection with a condenser 86. The condenser 86 is operative to release heat from the refrigerant material and to cause refrigerant vapor to condense. In the exemplary arrangement the condenser is operative to release the heat into the air adjacent to the lower portion of the body 70 of the refrigerator. In the exemplary arrangement the condenser is fluidly connected to the compressor 78 through a fluid conduit 88. Fluid conduit 88 further includes at least one disconnectable fluid loss preventing fitting 90 which may be similar to the fitting types previously discussed.

Of course it should be understood that the exemplary refrigerator includes additional components which are not shown in FIGS. 7-9. These include for example an accumulator, filter dryer, expansion valve and other components of the heat transfer fluid circuit. Such components condition and control the refrigerant flow so as to enable the refrigerant condensed in the condenser to expand in the evaporator in a heat transfer cycle.

In the exemplary arrangement the refrigerator includes a removable encasement 92. Encasement 92 is in operative supporting connection with the compressor 78. Encasement 92 is removable from the interior of the body 70 of the refrigerator when the compressor 78 is fluidly disconnected from the evaporator and the condenser by disconnection of the fittings 84 and 90.

In exemplary arrangements the encasement 92 is in supported connection with the refrigerator body through at least one resilient pad 94. Resilient pad 94 of the exemplary arrangement comprises a resilient shock absorbing pad of rubber or other material that is suitable for vibrationally isolating the encasement from the body of the refrigerator. A further resilient pad 96 extends between the encasement and the liner bounding the interior area 72. The further resilient pad extends generally vertically in the operational position.

The exemplary resilient pads are configured to be of such thickness and to have such vibration absorption properties so as to reduce the vibration which is inherent in the operation of the compressor from being transmitted from the encasement structure to the body of the refrigerator. This reduces the risk of vibration of the items housed within the refrigerator. Such low vibration may be highly desirable for certain types of beverages or other stored items. Further such vibration isolation capabilities may be desirable for structures adjacent to the refrigerator body or that are supported thereon, such as other electrical components of the appliances previously discussed. Further in exemplary arrangements the resilient pads can be configured to engage channels, projections, recesses or other structures of the body so as to avoid the need for metallic or other fasteners to directly extend between the encasement structure and the body of the refrigerator. Such approaches to engagement of the encasement structure and the refrigerator body may facilitate the removal and replacement thereof in the event of compressor failure. As a result, such exemplary arrangements facilitate being able to more readily repair the refrigerator while reducing the adverse effects of vibration which are inherent in the operation of compressors utilized with compact refrigerators. Of course it should be understood that these structures are exemplary and in other arrangements, other approaches may be used.

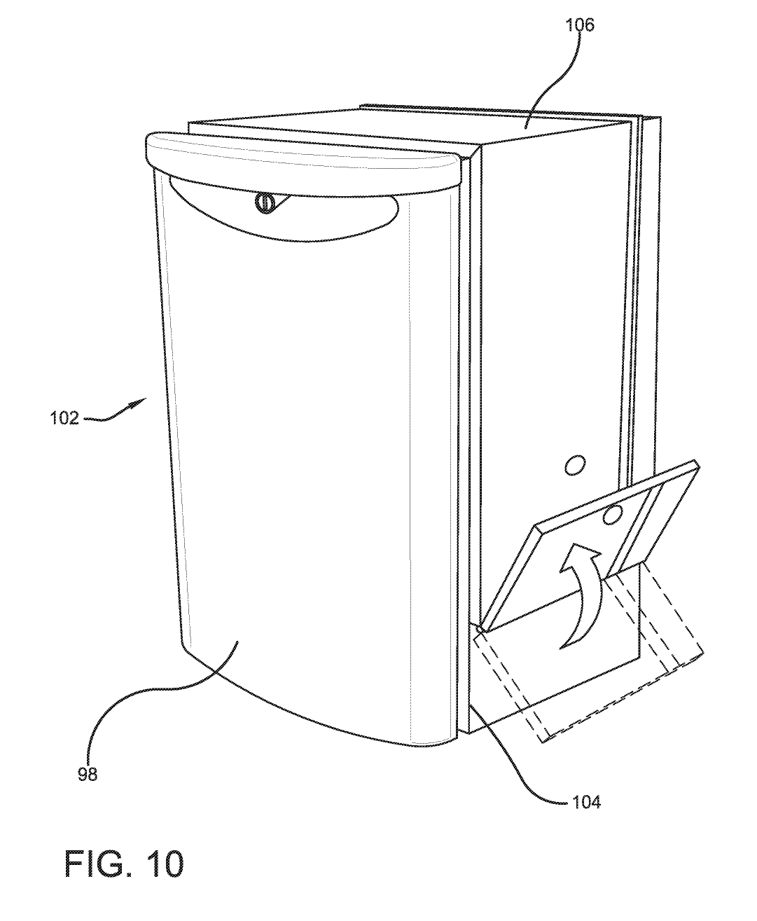

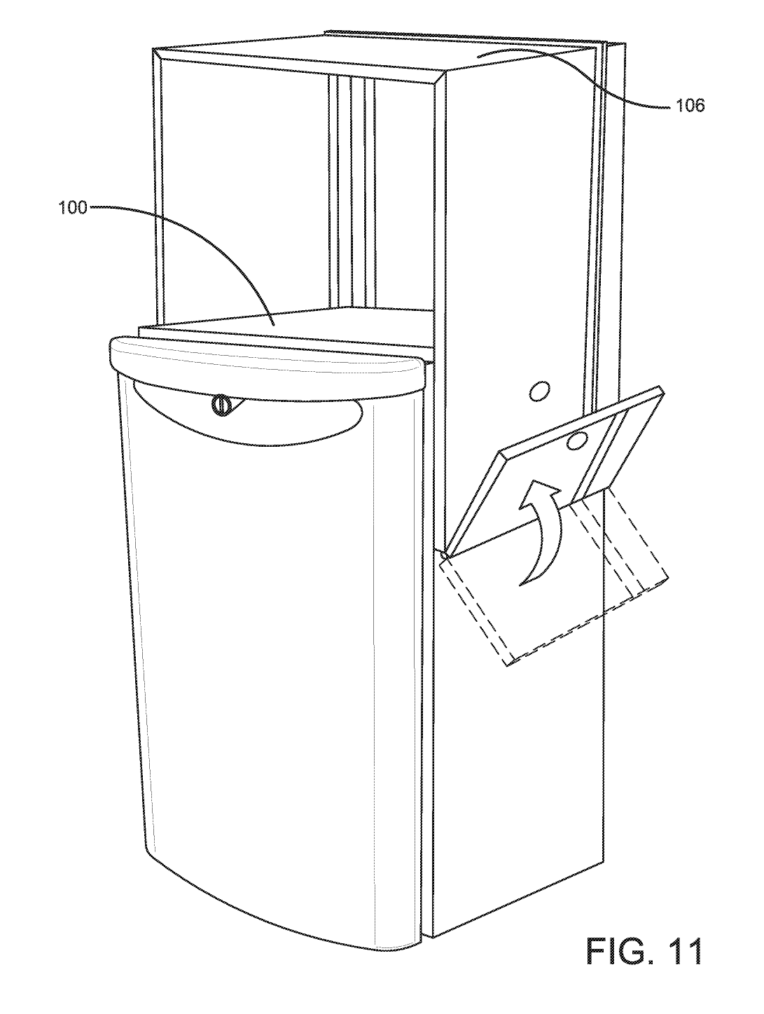

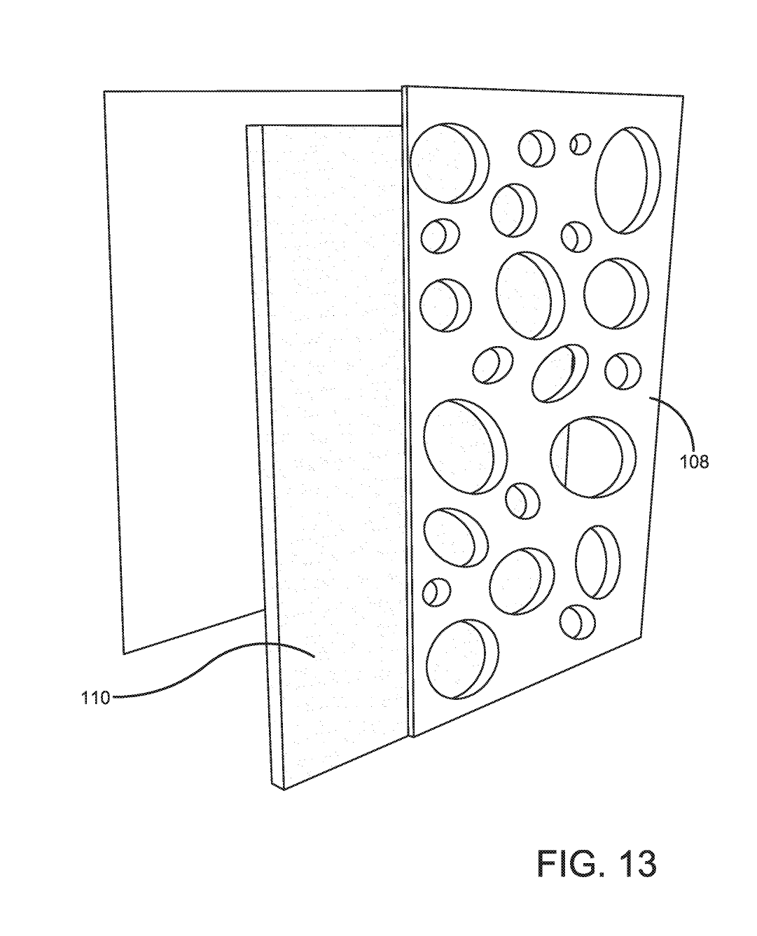

FIGS. 10-20 show an exemplary arrangement for a compact refrigerator insulating sleeve arrangement. The insulating sleeve of the exemplary embodiment extends adjacent to portions of at least three sides of a compact refrigerator so as to reduce the infiltration of heat into the interior area of the compact refrigerator. The exemplary sleeve arrangement is constructed so as to facilitate the installation of the sleeve onto different types of refrigerators and to facilitate the holding of the sleeve in engagement with the refrigerator.

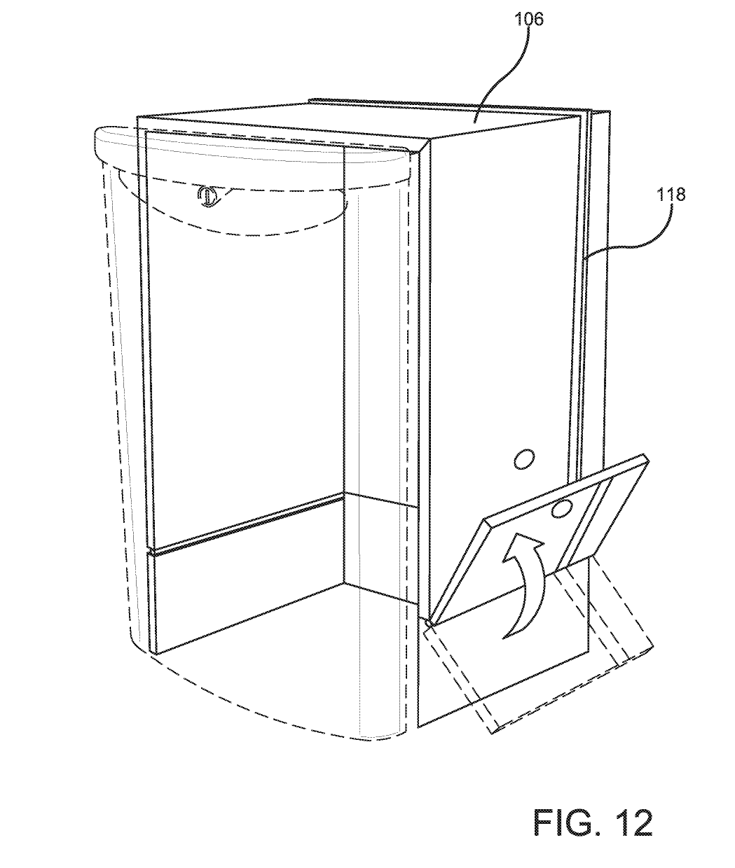

In the exemplary arrangement as represented in FIG. 10, a refrigerator 98 includes a top wall 100 and disposed side walls 102 and 104 which in the exemplary arrangement extend generally perpendicular to the top wall. As represented, an exemplary insulating sleeve 106 is configured to be conformed to the configuration of the top and side walls of the refrigerator and to be positioned thereon in engagement with at least portions of the top and external sides of the refrigerator. The engagement of such a sleeve is represented in FIGS. 10 and 12 to provide additional insulation so as to reduce the infiltration of heat from the environment into the interior area of the refrigerator.

In the exemplary arrangement the sleeve is comprised of a generally rigid backing plate 108. The backing plate 108 may be comprised of a thin, relatively rigid plastic or other material. Attached to the backing plate is a compressible insulation material 110. The compressible insulation may be comprised of a suitable insulating material such as fiberglass or elastomeric foam such as urethane foam. In exemplary arrangements the insulation may be attached to the backing plate through adhesives or other suitable attachment methods. Further it should be understood that while in exemplary arrangements the backing plate will generally not be visible once the refrigerator has been installed, in other arrangements the backing plate may be made decorative by having patterns, pictures or other items thereon. This is represented by the backing plate 112 shown in FIG. 14.

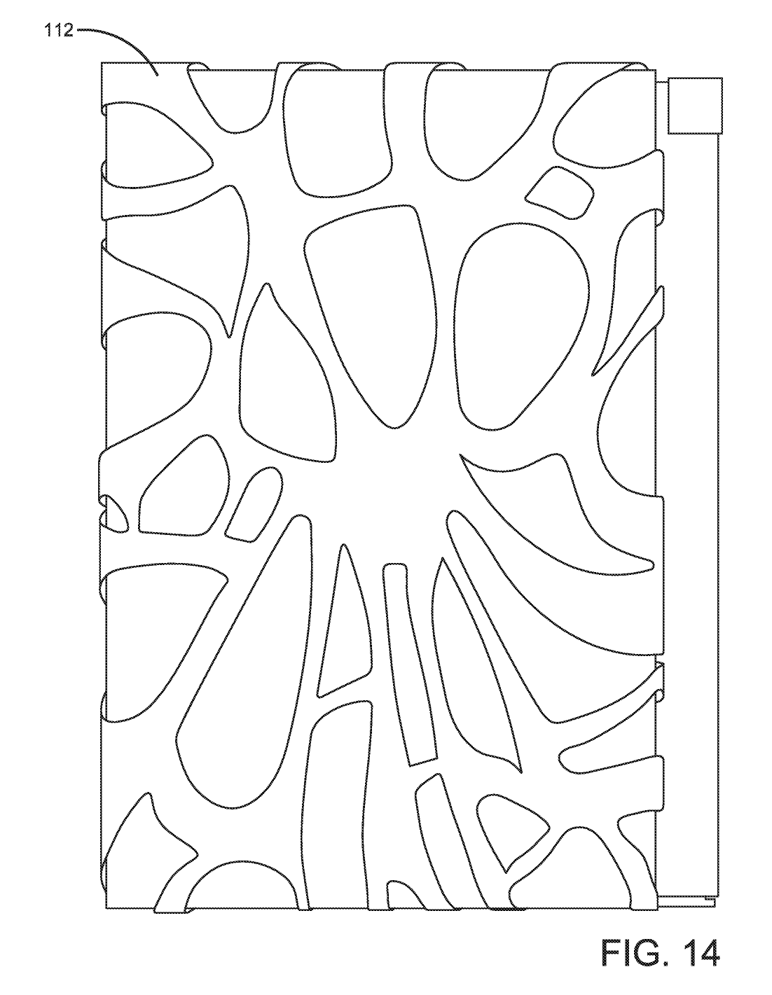

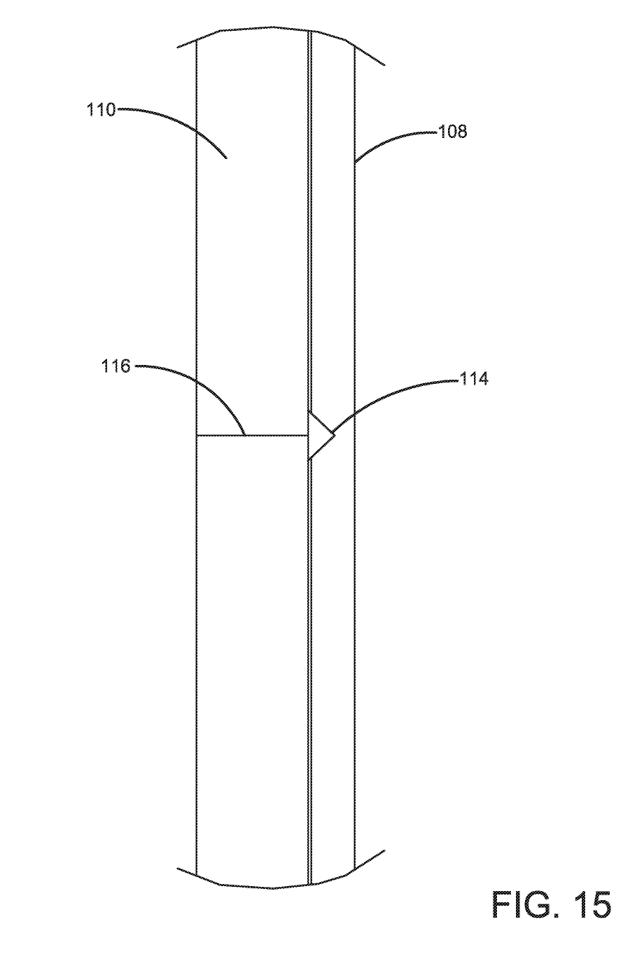

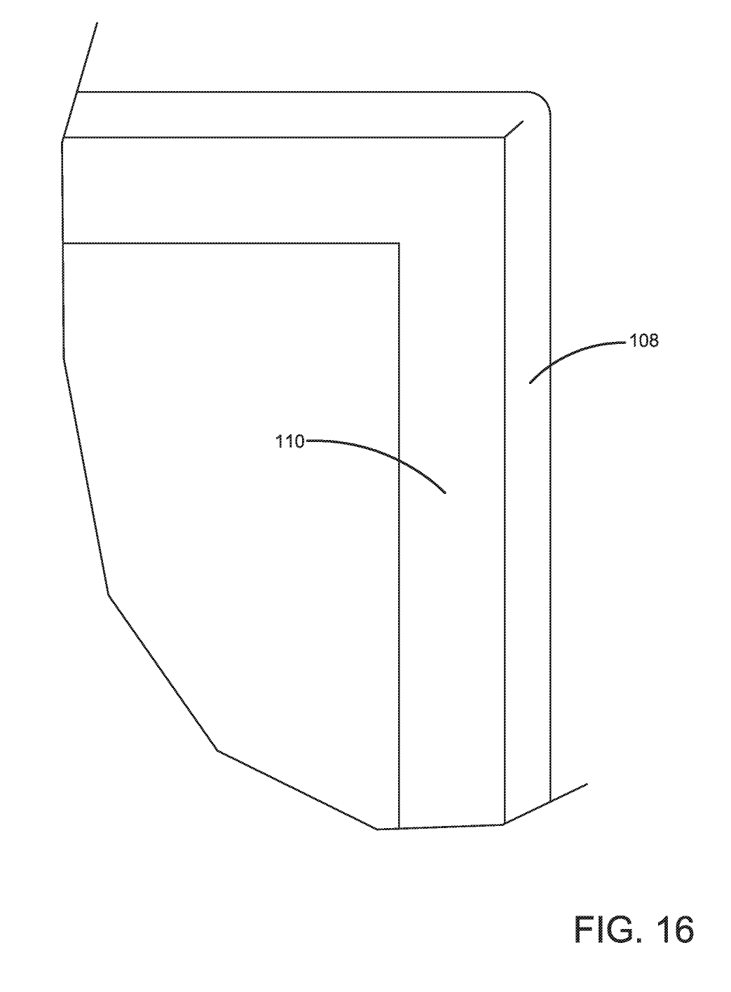

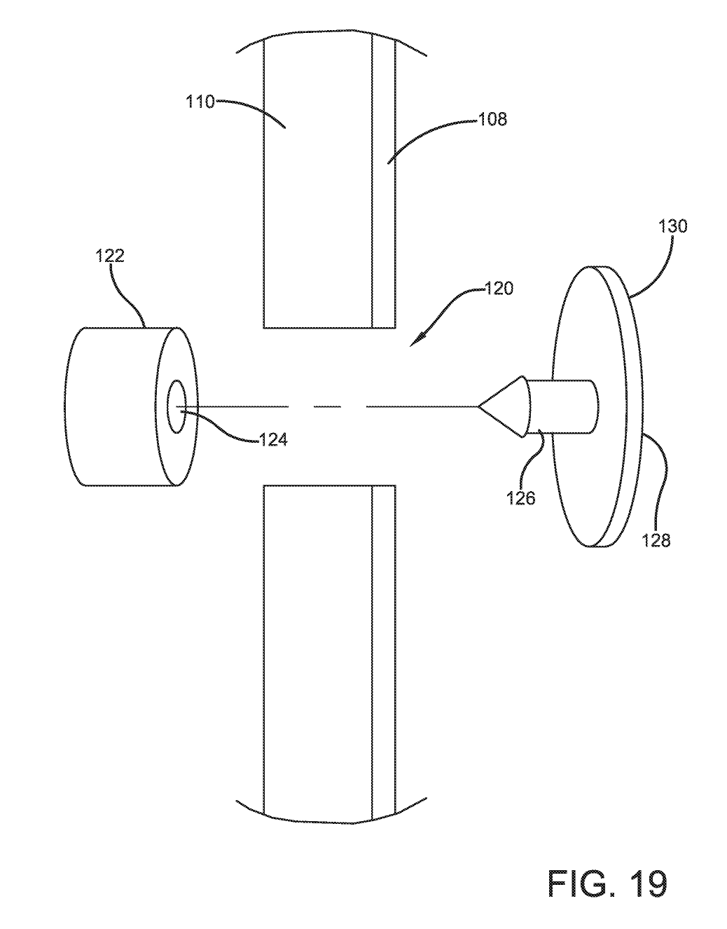

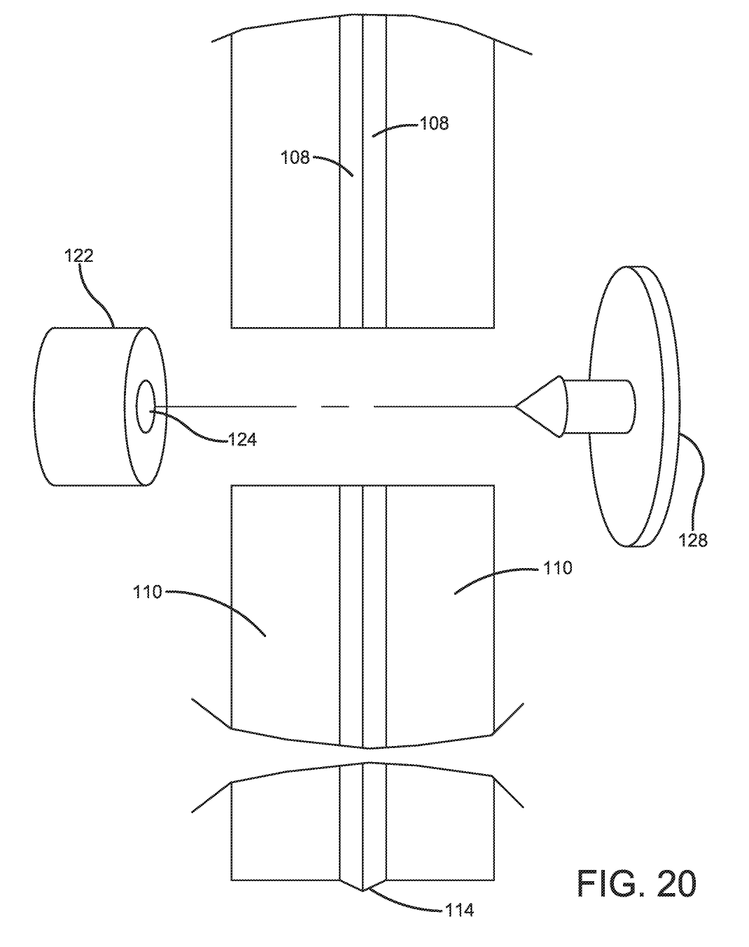

FIG. 15 shows an exemplary side view of the backing plate and insulating material. In the exemplary arrangement, the backing plate includes a plurality of thinned bend/break lines 114. Bend/break lines 114 of exemplary arrangements enable the backing plate to be bent along the bend/break line at least 90 degrees in an in-turned direction and at least 180 degrees in an out-turned direction without fracture. This enables for example the backing plate to be turned inward to conform to the 90 degree corners at the top wall of the refrigerator where the top 100 meets the side walls 102 and 104. This is represented in FIG. 16. Further as represented in FIGS. 10-12, the exemplary bend/break lines 114 enable the backing plate to be folded outwardly 180 degrees back onto itself for purposes of conforming the sleeve material to the height of the refrigerator. In the exemplary arrangement a plurality of bend/break lines extend parallel and at predetermined spaced distances along the backing plate. These parallel bend/break lines correspond to various configurations and lengths of the side walls of refrigerators. Further in the exemplary arrangement full or partial cuts 116 extend in the insulation 110 in aligned relation with the bend/break lines 114. Such cuts enable the backing plate to be turned outwardly as represented in FIG. 20, without stretching the insulation material. Of course it should be understood that this approach is exemplary and in other arrangements, other approaches may be used.

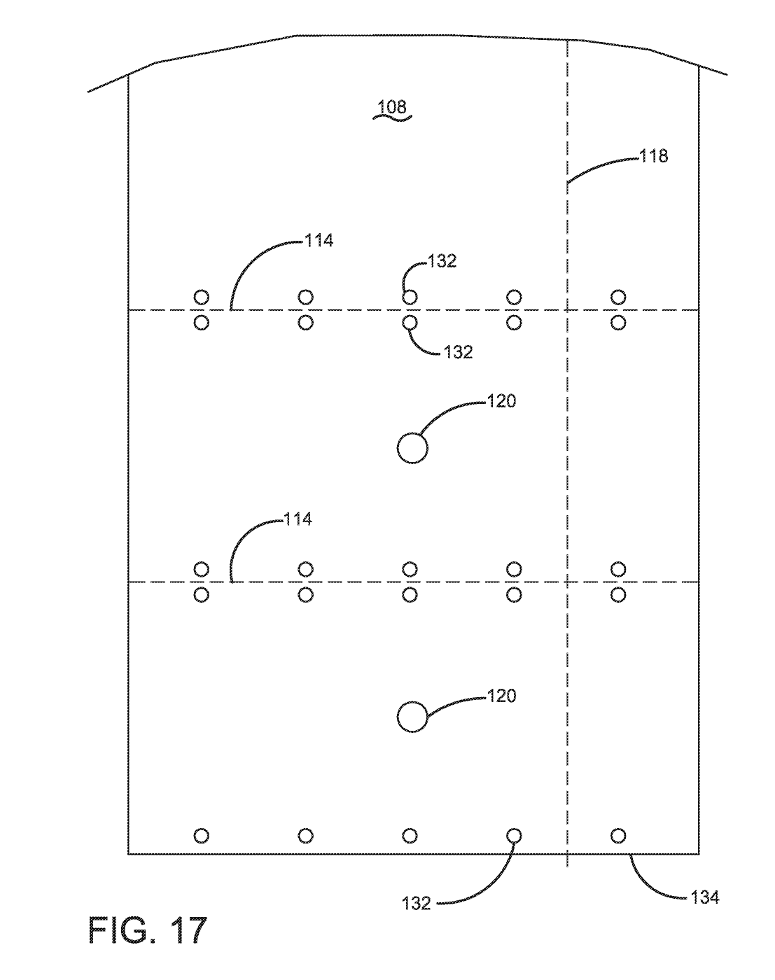

In the exemplary arrangement the backing plate 108 may further include frangible cut lines 118 such as represented in FIG. 17. In exemplary embodiments the frangible cut lines 118 extend generally transverse to the bend/break lines 114. The one or more frangible cut lines may comprise thinned and/or perforated lines in the backing plate that enable the separation of a lateral portion of the sleeve so as to conform to the width of a particular refrigerator. In exemplary arrangements the insulation 110 includes cuts similar to cuts 116 which correspond to the frangible cut lines 118. This enables the initial sleeve width to be reduced to the desired amount by fracturing the backing plate along a frangible cut line. Of course these approaches are exemplary and in other arrangements, other approaches may be used.

The exemplary sleeve further includes a plurality of preformed apertures 120. In the exemplary arrangement the preformed apertures are configured for receiving fasteners that are operative to hold the sleeve in engagement with the refrigerator. In some embodiments the apertures may have material therein that can be left in place and that may be removed only from the apertures to be utilized. Such “punch outs” provide insulation in areas where an aperture is not required for fastener attachment.

As represented in FIG. 19, the exemplary side walls of the refrigerator include at least one outward extending projection such as projection 122. Projection 122 is configured to be aligned with and extend in a preformed aperture 120. The exemplary projection 122 includes an opening 124. The opening 124 is configured to accept an engaging projection 126 of a snap connect fastener 128. As represented in FIG. 19, the exemplary snap connect fastener 128 includes a flange portion 130 that is sized to have a sufficient diameter so as to overlie the backing plate 108 adjacent to the aperture 120 when the snap connect fastener is in engagement therewith. As can be appreciated, the snap connect fastener is operative to enable holding the sleeve in engaged relation with the refrigerator. In exemplary arrangements such projections and snap connect fasteners are positioned on each lateral side 102, 104 of the refrigerator so as to hold the sleeve in engagement with each of the refrigerator side walls. Of course in other arrangements, other types of sleeve connecting arrangements may be used.

As represented in FIG. 20, in the exemplary arrangement the sleeve is enabled to be bent outwardly 180 degrees such that the sleeve is folded along the bend/break lines to enable the sleeve to be turned upwardly at the bottom. In the exemplary arrangement the sleeve is configured so that when the backing plate is turned 180 degrees at the break line, the preformed aperture 120 in the outwardly turned portion aligns with the projection and the aperture in the area of the sleeve adjacent to the side wall of the refrigerator. Such alignment enables the snap connect fastener 128 to hold the sleeve by extending through both apertures as represented in FIG. 20. The compressible nature of the insulation 110 enables the fastener to engage the opening of the projection 122 so as to provide suitable connecting engagement between the sleeve and the refrigerator.

It should be understood that although in some arrangements the sleeve may be cut at the bend/break lines so as to conform the length of the insulating sleeve to the refrigerator, an advantage of some exemplary embodiments is that such cutting is not necessary as the sleeve can be turned upwardly to shorten the length of the sleeve at the sides as appropriate.

As represented in FIG. 17, the exemplary embodiment may further include a plurality of connectors 132 adjacent to a terminating edge 134 that extends at the bottom of each side of the sleeve. In the exemplary arrangement the connectors comprise holes through the backing plate 110. Of course these connectors are exemplary and in other arrangements, other types of projections, recesses or interengaging structures may be used.

In the exemplary arrangement the connectors enable adding to the length of the sleeve so as to extend below the terminating edge. This might be done for example to have the insulating sleeve extend further downwardly to cover a greater portion of the side walls of a refrigerator that is taller than the length of the sides of the insulating sleeve as initially formed. Alternatively or in addition, the connectors may be utilized to extend the insulating sleeve across the bottom of the refrigerator should it be so desired. In other circumstances the insulating sleeve may be comprised of material that is left over from insulating another refrigerator such that the insulating sleeve is too short for the current refrigerator. In such circumstances it is desirable to add additional material to one or both sides of the insulating sleeve.

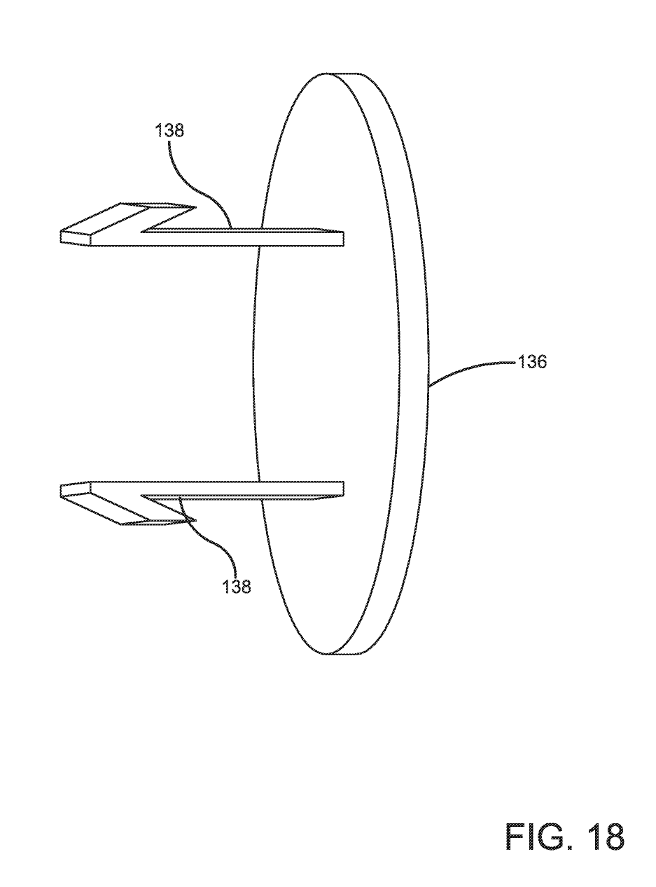

In the exemplary arrangement additional material may be connected to the terminating edge through the use of connector clips 136 shown in FIG. 18. The exemplary connector clip includes a pair of disposed clip projections 138. The clip projections 138 are barbed and configured to engage and hold in the connector holes 132 once they are extended therein.

In exemplary arrangements the connector clips can be utilized to engage the connector holes on one side of the terminating edge 134 with connector holes in a mating piece of sleeve material that may be attached thereto. As can be appreciated, multiple pieces of sleeve material may be added as necessary for purposes of extending the sleeve as desired.

In some exemplary embodiments, the connectors such as holes 132 may be positioned adjacent to each of the bend/break lines such as is represented in FIG. 17. By having such connectors adjacent to each side of the break lines, sleeve material may be more readily reused for purposes of insulating other refrigerators. For example, in some arrangements where sleeve material is cut at the bend/break lines to conform to a length of a refrigerator, the left over material may be utilized by connecting it to a terminating edge of other material so as to insulate another refrigerator. This reduces waste by allowing sections of insulating material to be utilized. Alternatively or in addition, connectors may be used to attach another layer of insulating sleeve material on top of an underlying sleeve. Further it should be appreciated that while in the exemplary arrangement the connectors are comprised of holes and connector clip structures. In other arrangements, other connectors may be comprised of projections, recesses, hinge structures or other suitable structures that enable connection of insulating material at or adjacent to a terminating edge and/or a bend/break line.

Thus the exemplary embodiments described achieve improved operation, eliminate difficulties encountered in the use of prior devices and systems and attain the useful results as described herein.

In the foregoing description, certain terms have been used for brevity, clarity and understanding. However, no unnecessary limitations are to be implied therefrom because such terms are used for descriptive purposes and are intended to be broadly construed. Moreover the descriptions and illustrations herein are by way of examples and the new and useful concepts are not limited to the features shown and described.

It should be understood that features and/or relationships associated with one embodiment can be combined with features and/or relationships of another embodiment. That is, various features and/or relationships from various embodiments can be combined in further embodiments. The inventive scope of the disclosure is not limited to only the embodiments shown or described herein.

Having described the features, discoveries and principles of the exemplary embodiments, the manner in which they are constructed and operated, and the advantages and useful results attained, the new and useful features, devices, elements, arrangements, parts, combinations, systems, equipment, operations, methods, processes and relationships are set forth in the appended claims.

We claim:

1. Apparatus comprising:
a secure container including a plurality of wall pieces, including
a bottom wall piece,
a top wall piece,
a first side wall piece,
a second side wall piece,
a back wall piece,
wherein the wall pieces define a container body having an interior area and an access opening opposite the back wall piece,
wherein a first one of the side wall pieces include
an outer bounding wall segment,
an engaging wall segment that extends parallel to and is disposed within the interior area
wherein the outer bounding wall segment and the engaging wall segment define an elongated slot,
wherein a second one of the wall pieces include
a latching edge portion, wherein the latching edge portion extends in the elongated slot,
wherein one of the engaging wall segment and the latching edge portion includes at least one tab and the other of the engaging wall segment and the latching edge portion includes at least one recess that is engaged with a respective tab, wherein the engaged at least one tab and at least one recess resist disengagement of the first and second wall pieces.

2. The apparatus according to claim 1 wherein a third one of the wall pieces includes
a further outer bounding wall segment that extends generally parallel of the outer bounding wall segment,
a further engaging wall segment wherein the further engaging wall segment extends generally parallel of the engaging wall segment,
wherein the further outer bounding wall segment and the further engaging wall segment define a further elongated slot,
wherein the second one of the wall pieces includes
a further latching edge portion, wherein the further latching edge portion is disposed generally opposite of the latching edge portion, wherein the further latching edge portion extends in the further elongated slot,
wherein one of the further latching edge portion and the further engaging wall segment includes at least one further tab and the other of the further latching edge portion and the further engaging wall segment includes at least one further recess, wherein the at least one further recess is in engagement with the at least one further tab.

3. The apparatus according to claim 2
wherein the engaging wall segment includes an aperture and the latching edge portion includes a further aperture, wherein a releasable fastener extends in both the aperture and the further aperture.

4. The apparatus according to claim 2
wherein the first one of the wall pieces includes the bottom wall piece,
the third one of the wall pieces includes the top wall piece, and
the second one of the wall pieces includes one of the first side wall piece and the second side wall piece and the back wall piece.

5. The apparatus according to claim 4
wherein the bottom wall piece includes
two bottom bounding wall side segments on two opposed lateral sides thereof,
two bottom engaging wall side segments, one of which is adjacent each bounding wall side segment, wherein each of which bottom bounding wall side segment and bottom engaging wall side segment define a respective elongated bottom side slot, and
a back bottom bounding wall segment at a back side thereof,
a back bottom engaging wall segment adjacent the back bottom bounding wall segment, which back bottom bounding wall and back bottom engaging wall segment define a back bottom slot,
wherein a lower latching edge portion of the first side wall piece is engaged in one of the elongated bottom side slots,
a lower latching edge portion of the second side wall piece is engaged in the other elongated bottom side slot,
a lower latching edge portion of the back wall piece is engaged in the back bottom slot,
wherein each of the bottom engaging wall side segments and back bottom engaging wall segment of the bottom wall piece includes at least one tab engaging recess, and each of the lower latching edge portions of the first side wall piece, the second side wall piece and the back wall piece include at least one recess engaging tab.

6. The apparatus according to claim 5
wherein the top wall piece includes
two top bounding wall side segments at opposed lateral sides thereof,
two top engaging wall side segments, one of which is adjacent each top bounding wall side segment and each of which top bounding wall side segment and top engaging wall segment define a respective elongated top side slot,
a back top bounding wall segment and a back side thereof,
a back top engaging wall segment adjacent the back top bounding wall segment, which back top bounding wall segment and back top engaging wall segment define a back top slot,
wherein an upper latching edge portion of the first side wall piece is engaged in one of the elongated top side slots, and
an upper latching edge portion of the second side wall piece is engaged in another of the top side slots,
an upper latching edge portion of the back wall piece is engaged in the back top slot,
wherein each of the top engaging wall side segments and back top engaging wall segment of the top wall piece includes at least one tab engaging recess, and each of the upper latching edge portions of the first side wall piece, the second side wall piece and the back wall piece include a recess engaging tab.

7. The apparatus according to claim 6
and further including
a door sized for closing the access opening,
wherein the door includes a lock thereon,
wherein the lock includes at least one bolt, wherein the bolt is selectively movable between an extended position and a retracted position,
wherein at least one side wall piece includes at least one strike, wherein the at least one strike includes at least one strike opening,
wherein in a closed position of the door closing the access opening and in the extended position of the at least one bolt, the at least one bolt extends in the at least one strike opening, wherein the door is held in the closed position.

8. The apparatus according to claim 7
wherein the door includes an inner door face, wherein the inner door face includes a strike recess,
wherein in the closed position of the door the at least one strike extends in the strike recess.

9. The apparatus according to claim 7
wherein the bottom wall piece includes a bottom shelf, wherein the bottom shelf includes a bottom hinge pin opening,
wherein the top wall piece includes a top shelf, wherein the stop shelf includes a top hinge pin opening, wherein the top hinge pin opening and the bottom hinge pin opening are aligned along an axis,
wherein the door is in operative connection with a top hinge pin and a bottom hinge pin, wherein the top hinge pin is operatively engaged in the stop hinge pin opening and the bottom hinge pin is operatively engaged in the bottom hinge pin opening, wherein the door is rotatable about the axis.

10. The apparatus according to claim 9
wherein each of the top hinge pin and the bottom hinge pin are selectively extendable and retractable from the door,
whereby the door in an open position and disposed from closing the access opening can be engaged with and disengaged from the container body.

11. The apparatus according to claim 10
wherein the door inner face includes a hinge pin recess,
wherein the top hinge pin and the bottom hinge pin can be selectively extended and retracted from the door through engagement thereof in the hinge pin recess.

12. The apparatus according to claim 9
wherein the bottom shelf includes an upward extending stop, and
the top shelf includes a downward extending stop,
wherein both stops prevent the door in the closed position from being moved further into the interior area.

13. The apparatus according to claim 12
wherein the upward extending stop comprises a bottom turned edge of the bottom shelf, and the downward extending stop comprises a top turned edge of the top shelf,
wherein each of the top turned edge and the bottom turned edge extend substantially an entire width of the access opening.

14. The apparatus according to claim 12
wherein each tab comprises a punched opening extending in a respective wall portion, wherein the opening extends generally perpendicular of the wall portion.

15. The apparatus according to claim 14
wherein the tab includes a catch surface at a first end, wherein the catch surface is sheared and disposed away from the wall portion in the area of the catch surface,
a smooth rounded second end surface opposed of the first end surface,
and a pair of rounded side surfaces, wherein the second end surface and the side surfaces are continuous with the wall portion,
wherein a catch surface is configured to engage an edge bounding a tab engaging recess.

16. The apparatus according to claim 14
wherein the wall pieces and the door are configured to be assembled to form the container body and to have the door attached to the container body, manually and without the use of tools.

17. The apparatus according to claim 14
wherein the wall pieces and the door are configured to be in separated flat stacked condition prior to assembly into the container body.

18. The apparatus according to claim 14
wherein the container body is configured to be included in an appliance unit in intermediate stacked relation between a refrigerator and a microwave oven.

19. The apparatus according to claim 18
wherein at least one component of the container receives power from at least one of the refrigerator and the microwave.

20. The apparatus according to claim 18
wherein the interior area includes a power connector configured for charging a battery of a mobile device.
